(19) United States
(12) Patent Application Publication
(10) Pub. No.: US 2018/0136151 A1
(43) Pub. Date: May 17, 2018

(54) HEAT DISSIPATION MEASURE DETERMINATION METHOD AND INFORMATION PROCESSING DEVICE

(71) Applicant: FUJITSU LIMITED, Kawasaki-shi (JP)

(72) Inventors: YASUSHI URAKI, Kawasaki (JP); Akihiko Fujisaki, Kawasaki (JP)

(73) Assignee: FUJITSU LIMITED, Kawasaki-shi (JP)

(21) Appl. No.: 15/728,603

(22) Filed: Oct. 10, 2017

(30) Foreign Application Priority Data
Nov. 17, 2016 (JP) 2016-224455

(51) Int. Cl. G01N 25/20

(52) U.S. Cl. CPC G01N 25/20; H04N 1/00984

(57) ABSTRACT

A non-transitory, computer-readable recording medium having stored therein a program for causing a computer to execute a process that includes: obtaining a heat generation amount of a component via an interface; calculating a unit heat-generation amount using the heat-generation amount of a component, and a unit size that is one of a volume of the component and a surface area of the component, the unit heat-generation amount being the heat-generation amount per the unit size; determining whether the unit heat-generation amount is greater than a threshold value; and causing an output device to output a signal for indicating that consideration of heat dissipation measures is desired for the component for which the unit heat-generation amount is determined to be greater than the threshold value.

### CROSS-REFERENCE TO RELATED APPLICATION

This application is based upon and claims the benefit of priority of the prior Japanese Patent Application No. 2016-224455, filed on Nov. 17, 2016, the entire contents of which are incorporated herein by reference.

### FIELD

The embodiments discussed herein are related to a heat dissipation measure determination method, an information processing device, and a computer-readable recording medium in which a heat dissipation measure determination program is stored.

### BACKGROUND

Various techniques for performing a thermal fluid analysis simulation are known. For instance, a technique is known, which generates a thermal contact resistance model at a contact portion of each of constituent members, and automatically calculates a thermal contact resistance and a thermal conductivity for the thermal contact resistance model (see, for instance, Japanese Laid-open Patent Publication No. 2007-122506). Also, another technique is known, which analyzes temperature distribution using a model that has parameters such as the area and position of an input region of an inputted heat flow, a physical property value such as a thermal conductivity, and the size of a circuit substrate (see, for instance, Japanese Laid-open Patent Publication No. 2004-192606).

However, it is not easy to determine whether or not heat dissipation measures are to be taken for each of the components disposed on a substrate before execution of a thermal fluid analysis simulation.

### SUMMARY

According to an aspect of the embodiments, a non-transitory, computer-readable recording medium having stored therein a program for causing a computer to execute a process that includes: obtaining a heat generation amount of a component via an interface; calculating a unit heat-generation amount using the heat-generation amount of a component, and a unit size that is one of a volume of the component and a surface area of the component, the unit heat-generation amount being the heat-generation amount per the unit size; determining whether the unit heat-generation amount is greater than a threshold value; and causing an output device to output a signal indicating that consideration of heat dissipation measures is desired for the component for which the unit heat-generation amount is determined to be greater than the threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example image corresponding to CAD data used for creation of a thermal fluid analysis model;

FIG. 1B is a diagram illustrating an example heat generation table used for determination of desirability of heat dissipation measures before execution of a thermal fluid analysis simulation in related art;

FIG. 1C is a diagram illustrating an example element disposed on a substrate;

FIG. 2 is a diagram illustrating an information processing device according to a first embodiment;

FIG. 3A is a diagram illustrating an example heat generation density table to be stored in a storage section illustrated in FIG. 2;

FIG. 3B is a diagram illustrating a relationship between a heat generation amount, a volume and a heat generation density depicted in the heat generation density table illustrated in FIG. 3A;

FIG. 4 is a flowchart of heat dissipation measure determination processing in the information processing device illustrated in FIG. 2;

FIG. 5A is a diagram illustrating an example mounting substrate on which components are mounted;

FIG. 5B is a diagram illustrating an example heat generation density table in which the heat generation amounts of the components are stored by the processing in S101;

FIG. 5C is a diagram illustrating an example heat generation density table in which the volumes of the components are stored by the processing in S102;

FIG. 5D is a diagram illustrating an example heat generation density table in which the heat generation densities of the components are stored by the processing in S103;

FIG. 5E is a table illustrating an example image corresponding to a heat dissipation consideration signal outputted by the processing in S106;

FIG. 6 is a diagram illustrating an information processing device according to a second embodiment;

FIG. 7 is a flowchart of heat dissipation measure determination processing in the information processing device illustrated in FIG. 6;

FIG. 8A is a diagram illustrating an example contact area ratio table to be stored in the storage section illustrated in FIG. 6;

FIG. 8B is a diagram for explaining the processing in S207 to S209;

FIG. 9 is a flowchart illustrating more detailed processing in S210;

FIG. 10A is a diagram illustrating an example contact area ratio of a mounting substrate;

FIG. 10B is a diagram illustrating an example image corresponding to a heat dissipation consideration signal outputted by the processing in S211;

FIG. 11 is a diagram illustrating an information processing device according to a third embodiment;

FIG. 12 is a flowchart of heat dissipation measure determination processing in the information processing device illustrated in FIG. 11;

FIG. 13 is a flowchart illustrating more detailed processing in S411;

FIG. 14A is a diagram illustrating an example determination result of heat dissipation measure determination processing for a mounting substrate made by the information processing device illustrated in FIG. 11;

FIG. 14B is a table illustrating a relationship between heat generation density and determination result made by the heat dissipation measure determination processing;

FIG. 14C is a table illustrating a relationship between thermal connection state of each component and determination result made by the heat dissipation measure determination processing;

FIG. 14D is a diagram illustrating an example image corresponding to a heat dissipation consideration signal outputted by the processing in S412;

FIG. 15 is a diagram illustrating an information processing device according to a fourth embodiment;

FIG. 16 is a diagram illustrating an example thermal conductivity table to be stored in a storage section illustrated in FIG. 15;

FIG. 17 is a flowchart of heat dissipation measure determination processing in the information processing device illustrated in FIG. 15;

FIG. 18 is a flowchart illustrating more detailed processing in S612;

FIG. 19A is a diagram illustrating an example component that is a target component on which thermal-conductive state determination processing is performed;

FIG. 19B is a diagram illustrating an example determination result as to the thermal connection state of a target component on which thermal-conductive state determination processing is performed;

FIG. 19C is a diagram illustrating an example image corresponding to a thermal conductive state signal outputted by the processing in S613;

FIG. 20 is a diagram illustrating an information processing device according to a fifth embodiment;

FIG. 21 is a diagram illustrating an example heat generation amount per unit area table to be stored in a storage section illustrated in FIG. 20;

FIG. 22 is a flowchart of heat dissipation measure determination processing in the information processing device illustrated in FIG. 20;

FIG. 23A is a perspective view illustrating an example analysis model;

FIG. 23B is an exploded perspective view of the analysis model illustrated in FIG. 23A;

FIG. 23C is a first side view of the analysis model illustrated in FIG. 23A;

FIG. 23D is a second side view of the analysis model illustrated in FIG. 23A;

FIG. 24 is a diagram illustrating an example image corresponding to an output signal including the analysis model illustrated in FIG. 23A;

FIG. 25 is a diagram illustrating an example image corresponding to an output signal including an analysis model which corresponds to the analysis models illustrated in FIG. 23A and in which C component is presumably discontinuous;

FIG. 26A is a diagram illustrating a modification example of an image corresponding to an output signal outputted from an information processing device according to the embodiments; and

FIG. 26B is a diagram illustrating another modification example of an image corresponding to an output signal outputted from an information processing device according to the embodiments.

### DESCRIPTION OF EMBODIMENTS

Hereinafter, a heat dissipation measure determination program, a heat dissipation measure determination method, and an information processing device that executes the heat dissipation measure determination program according to the present disclosure will be described with reference to the drawings. However, the technical scope of the present disclosure is not limited to those embodiments.

### Determination of Desirability of Heat Radiation Measures Before Execution of Thermal Fluid Analysis Simulation in Related Art

Before a heat dissipation measure determination program according to an embodiment is described, determination of desirability of heat dissipation measures before execution of a thermal fluid analysis simulation in related art will be described.

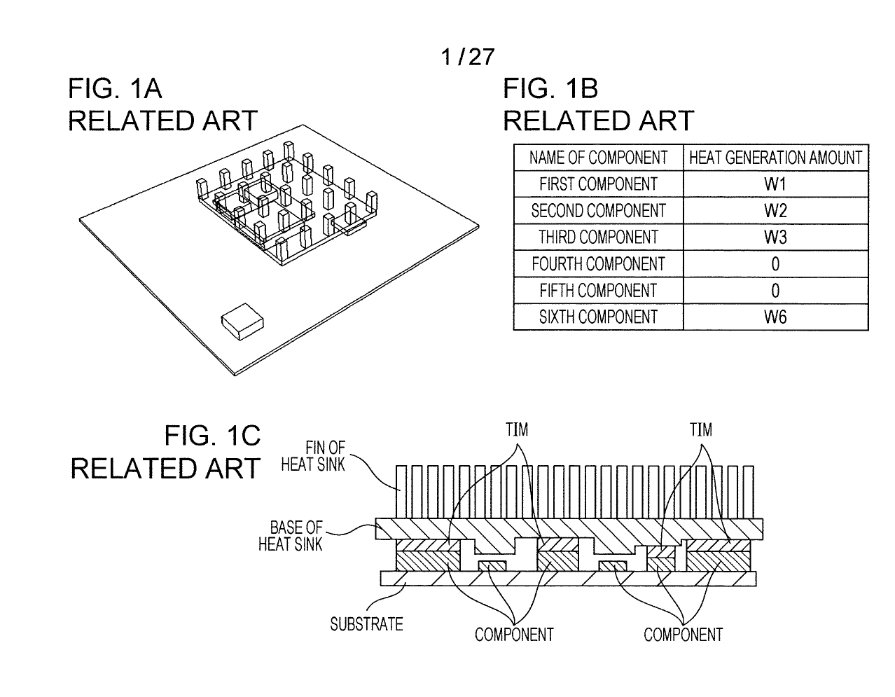

FIG. 1A is a diagram illustrating an example image corresponding to CAD data used for creation of a thermal fluid analysis model, and FIG. 1B is a diagram illustrating an example heat generation table used for determination of desirability of heat dissipation measures before execution of a thermal fluid analysis simulation in related art. FIG. 1C is a diagram illustrating an example element disposed on a substrate.

A thermal fluid analysis model is created using CAD data corresponding to the image as illustrated in FIG. 1A. A designer determines whether or not a component, for which heat dissipation measures are not taken, is present in a thermal fluid analysis model created using CAD data corresponding to the image as illustrated in FIG. 1A. Specifically, a designer extracts a component with a large heat generation amount from the heat generation table illustrated in FIG. 1B, visually compares the component with a corresponding component in the thermal fluid analysis model, and determines whether or not a component, for which heat dissipation measures are not taken, is present. For instance, it is determined whether or not a component with a large heat generation amount is in contact with a heat dissipation member such as a heat sink or a thermal interface material (TIM) by visually checking the contact portion between a component of a thermal fluid analysis model and a heat dissipation member at an enlarged scale.

However, as illustrated in FIG. 1C, the sectional shape of the base of a heat sink is complicated and many projections or depressions are present because the heights of components mounted on a substrate are different. Since the sectional shape of the base of a heat sink is complicated, visual determination by a designer may cause the work of the designer to be complicated, and a thermal failure may be overlooked. Then, when a heat generation amount per unit size calculated from the heat generation amount of each component and a parameter that varies with the size of each component is greater than a unit heat generation amount threshold value, the heat-dissipation measure determination program according to the embodiment outputs a heat dissipation consideration signal indicating that consideration of heat dissipation measures is desired. An example of a parameter that varies with the size of each component is a heat generation density obtained by dividing the heat generation amount of the component by the volume of the component, and another example of a parameter that varies with the size of each component is a unit surface area heat generation amount obtained by dividing the heat generation amount of the component by the surface area the component. Determination of desirability of consideration of heat dissipation measures using a unit heat generation amount when the size of a component is a predetermined unit size, rather than the heat generation amount of the component allows desirability of heat dissipation measures for a component with a small heat generation amount and a small size to be determined without fail.

### Configuration and Function of Information Processing Device According to First Embodiment

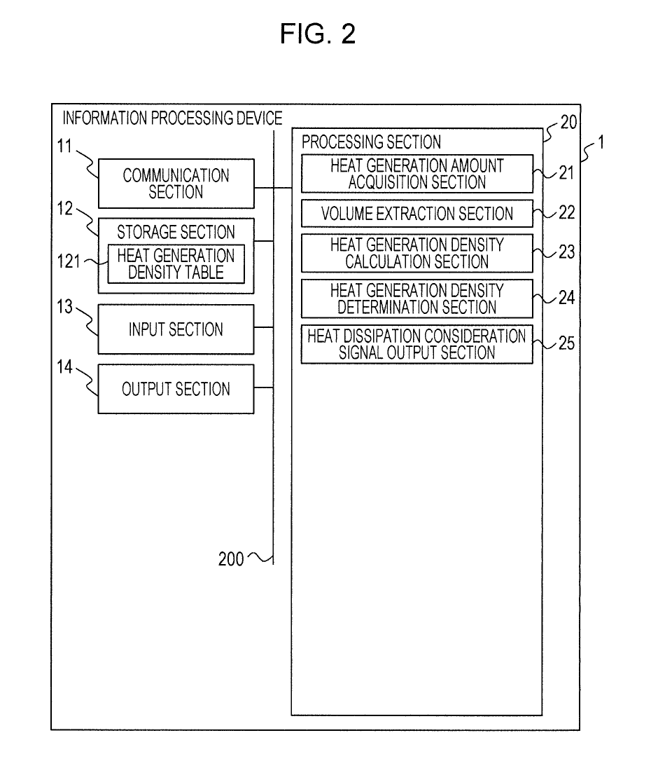

FIG. 2 is a diagram illustrating an information processing device according to a first embodiment.

An information processing device 1 has a communication section 11, a storage section (memory) 12, an input section 13, an output section 14, and a processing section 20. The communication section 11, the storage section 12, the input section 13, the output section 14, and the processing section 20 are coupled to each other via a bus 200. When the unit heat generation amount calculated using the heat generation amount of each component and a parameter that varies with the size of each component is greater than a heat generation density threshold value, the information processing device 1 executes a heat dissipation measure determination program that outputs a heat dissipation consideration signal indicating that consideration of heat dissipation measures is desired for the component.

The communication section 11 has a wired communication interface circuit such as Ethernet (trademark). The communication section 11 communicates with another information processing device via a LAN which is not illustrated.

The storage section 12 includes, for instance, at least one of a semiconductor memory device, a magnetic tape device, a magnetic disk drive, and an optical disk device. The storage section 12 stores an operating system program, a driver program, an application program, and data which are used for processing by the processing section 20. For instance, the storage section 12 stores a heat dissipation measure determination program as an application program. The heat dissipation measure determination program may be installed to the storage section 12 from, for instance, a computer-readable portable type recording medium such as a CD-ROM, a DVD-ROM using a publicly known setup program or the like.

In addition, the storage section 12 stores various data used in the processing which is executed using the heat dissipation measure determination program. For instance, the storage section 12 stores an analysis model data indicating an analysis model used for thermal fluid analysis. In addition, the storage section 12 stores a heat generation density table 121 in which the heat generation amount, the volume, and the heat generation density of each of the components mounted on a substrate are associated with each other. Also, the storage section 12 may temporarily store temporary data related to predetermined processing.

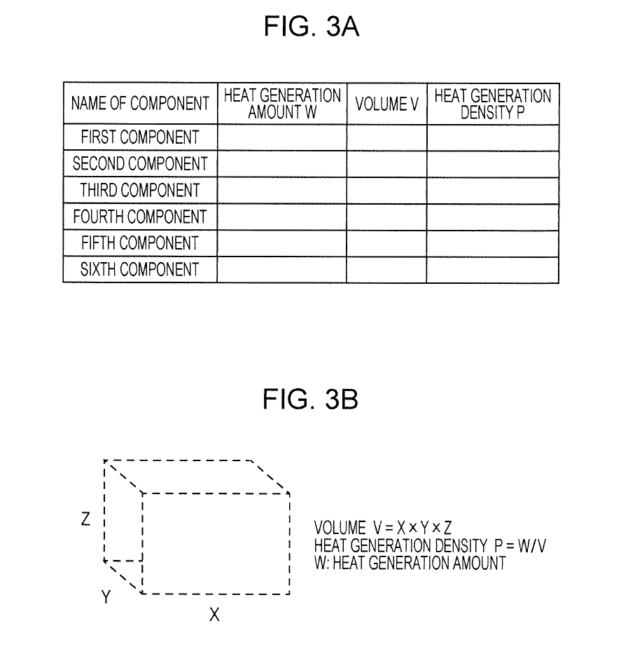

FIG. 3A is a diagram illustrating an example of the heat generation density table 121 to be stored in the storage section 12, and

FIG. 3B is a diagram illustrating a relationship between the heat generation amount, volume and heat generation density depicted in the heat generation density table illustrated in FIG. 3A.

The heat generation density table 121 stores a heat generation amount W of each component acquired by the processing section 20. Also, the heat generation density table 121 stores the volume of each component extracted by the processing section 20. A volume V of a component is extracted as (V=X×Y×Z) from the width X, depth Y, height Z of the component. In addition, the heat generation density table 121 stores a heat generation density P of each component calculated by the processing section 20. The heat generation density P of a component is calculated by dividing the heat generation amount W of the component by the volume V (P=W/V) of the component.

The input section 13 may be any device as long as the device allows input of data. The input section 13 is, for instance, a touch panel, a keyboard or the like. An operator may input a character, a numeral, a symbol, etc. using the input section 13. The input section 13, when being operated by an operator, generates a signal corresponding to the operation. The generated signal is then supplied to the processing section 20 as an instruction of the operator.

The output section 14 may be any device as long as the device allows display of a picture, an image. The output section 14 is, for instance, a liquid crystal display or an organic electro-luminescence (EL) display. Also, the output section 14 may have a communication function and may be a device of an information processing device connected to a network. The output section 14 displays an image according to image data, or a picture according picture data both supplied from the processing section 20. Also, the output section 14 may be an output device that prints a picture, an image, or a character on a display medium such as paper. Also, the output section 14 may have a communication function, and may print a picture, an image, or a character on a display medium such as paper, in an output device of an information processing device connected to a network.

The processing section 20 has one or multiple processors and their peripheral circuits. The processing section 20 controls the overall operation of the information processing device 1 in an integrated manner, and is a CPU, for instance. The processing section 20 performs processing based on the programs (such as a driver program, an operating system program, an application program) stored in the storage section 12. In addition, the processing section 20 allows parallel execution of multiple programs (such as application programs).

The processing section 20 has a heat generation amount acquisition section 21, a volume extraction section 22, a heat generation density calculation section 23, a heat generation density determination section 24, and a heat dissipation consideration signal output section 25. These sections are functional modules implemented by programs each of which is executed by a processor included in the processing section 20. Alternatively, these sections may be mounted in the information processing device 1 as firmware.

### Heat Dissipation Measure Determination Processing by Information Processing Device According to First Embodiment

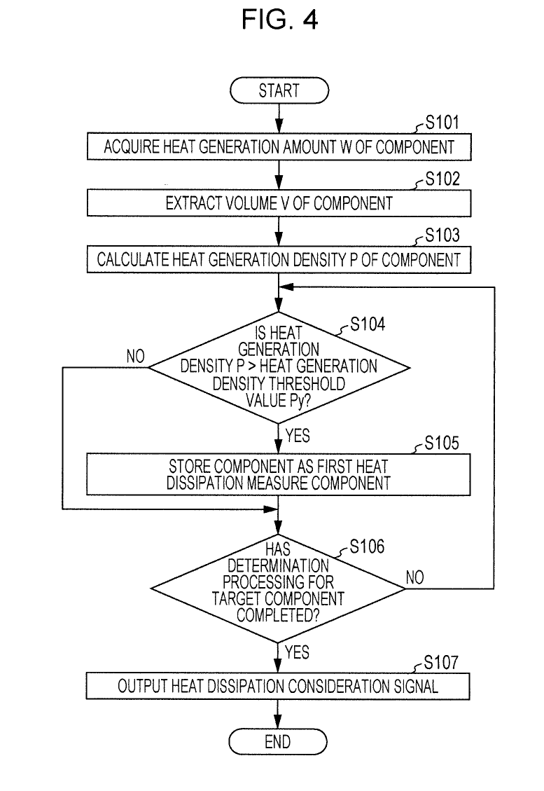

FIG. 4 is a flowchart of heat dissipation measure determination processing in the information processing device 1. The heat dissipation measure determination processing illustrated in FIG. 4 is performed mainly by the processing section 20 that cooperates with each element of the information processing device 1 based on a program pre-stored in the storage section 12.

First, the heat generation amount acquisition section 21 acquires the heat generation amount W of each component mounted on a substrate (S101), and stores the acquired heat generation amount W in the heat generation density table 121 in association with the component name. Subsequently, the volume extraction section 22 extracts the volume V of a component with a heat generation amount greater than 0, that is, a component with a non-zero heat generation amount (S102), and stores the extracted volume V in the heat generation density table 121 in association with the component name and the heat generation amount W. Subsequently, the heat generation density calculation section 23 calculates the heat generation density P of each component with a non-zero heat generation amount W using the heat generation amount W and the volume V of the component stored in the heat generation density table 121 (S103), and stores the calculated heat generation density P in the heat generation density table 121 in association with the component name. Subsequently, the heat generation density determination section 24 determines whether or not the heat generation density P calculated by the processing in S103 is greater than a predetermined heat generation density threshold value Py (S104). When it is determined that the heat generation density P is greater than the heat generation density threshold value Py (YES in S104), the heat generation density determination section 24 stores in the storage section 12 the component as a first heat dissipation measure component for which consideration of heat dissipation measures is desired (S105). The heat generation density determination section 24 determines whether or not the determination processing in S104 has been performed on all the components which are stored in the heat generation density table 121 and each of which has a non-zero heat generation amount W (S106). The heat generation density determination section 24 repeats the processing in S104 to S106 until it is determined that the determination processing in S104 has been performed on all the components which are stored in the heat generation density table 121 and each of which has a non-zero heat generation amount W (YES in S106). When it is determined that the determination processing in S104 has been performed on all the components, each of which has a non-zero heat generation amount W (YES in S106), the heat dissipation consideration signal output section 25 outputs a heat dissipation consideration signal indicating that consideration of heat dissipation measures is desired for the first heat dissipation measure components stored in the storage section 12 (S107).

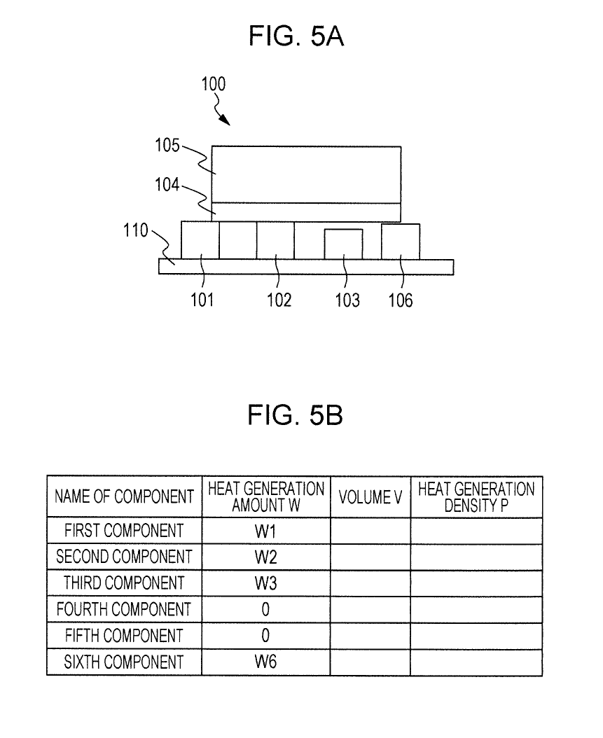

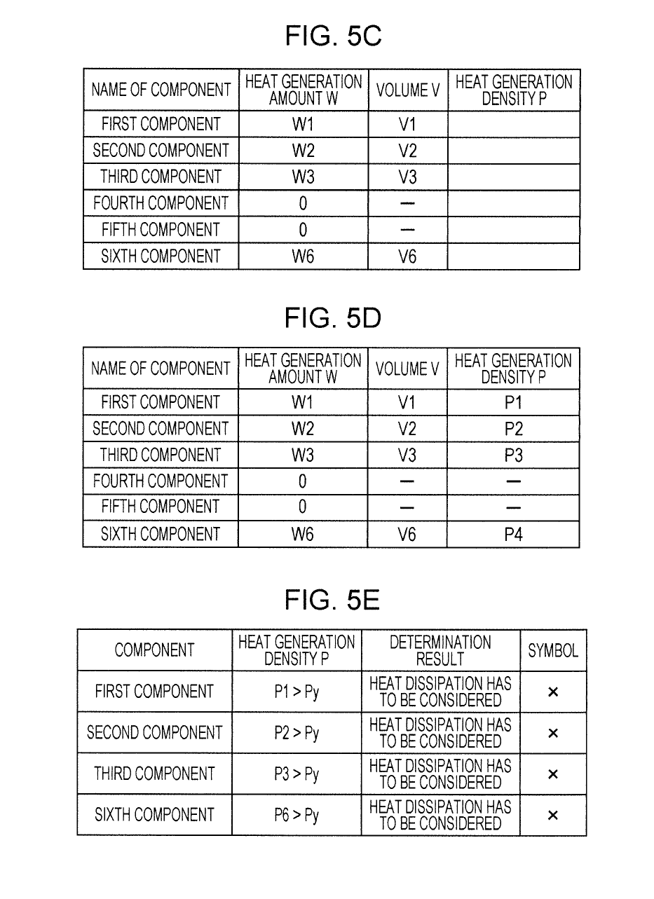

FIG. 5A is a diagram illustrating an example mounting substrate on which components are mounted, and FIG. 5B is a diagram illustrating an example of the heat generation density table 121 in which the heat generation amounts W of the components are stored by the processing in S101. FIG. 5C is a diagram illustrating an example of the heat generation density table 121 in which the volumes of the components are stored by the processing in S102, and FIG. 5D is a diagram illustrating an example of the heat generation density table 121 in which the heat generation densities of the components are stored by the processing in S103. FIG. 5E is a table illustrating an example of an image corresponding to a heat dissipation consideration signal outputted by the processing in S106.

The mounting substrate 100 has a printed circuit board (PCB) 110, and a first component 101, a second component 102, a third component 103, a fourth component 104, a fifth component 105, and a sixth component 106 that are mounted on the PCB 110. The first component 101, the second component 102, the third component 103, and the sixth component 106 are each a heat generating component, such as a resistance element or a semiconductor element. The fourth component 104 is a TIM, the fifth component 105 is a heat sink having a base and fins, and both the fourth component 104 and the fifth component 105 have zero heat generation amount.

The heat dissipation measure determination processing performed by the information processing device 1 will be specifically described using the mounting substrate 100 as an example. First, the heat generation amount acquisition section 21 acquires the heat generation amount W of each component mounted on the mounting substrate 100 (S101), and stores the heat generation amount W in the heat generation density table 121 in association with the component name. As an example, the heat generation amount acquisition section 21 acquires the heat generation amount W of each of the first component 101 to the sixth component 106 from the heat generation table which stores the component name and the heat generation amount W of each of the first component 101 to the sixth component 106 in association with each other. In another example, the heat generation amount acquisition section 21 acquires the heat generation amount W inputted via the input section 13 in association with the component name. As illustrated in FIG. 5B, the heat generation amount of the first component is W1 [W], the heat generation amount of the second component is W2 [W], the heat generation amount of the third component is W3 [W], the heat generation amount of the fourth component and the fifth component are 0 [W], and the heat generation amount of the sixth component is W6 [W].

Subsequently, the volume extraction section 22 extracts the volume V of the first component 101 to the third component 103 and the sixth component 106 each with a non-zero heat generation amount W (S102), and stores the extracted volume V in the heat generation density table 121 in association with the component name and the heat generation amount W. As an example, from an analysis model corresponding to analysis model data stored in the storage section 12, the volume extraction section 22 extracts the volume V (=X×Y×Z) of a component from the width X, depth Y, and height Z of each of the first component 101 to the third component 103 and the sixth component 106. As illustrated in FIG. 5C, the volume of the first component 101 is V1 [m³], the volume of the second component 102 is V2 [m³], the volume of the third component 103 is V3 [m³], and the volume of the sixth component 106 is V6 [m³].

Subsequently, the heat generation density calculation section 23 calculates the heat generation density P of each of the first component 101 to the fourth component 104 and the sixth component 106 each with a non-zero heat generation amount using the heat generation amount W and the volume V of relevant components stored in the heat generation density table 121 (S103). The heat generation density P is the value (P=W/V) obtained by dividing the heat generation amount W of a component by the volume V of the component. As illustrated in FIG. 5D, the heat generation density of the first component is P1 (=W1/V1) [W/m³], the heat generation density of the second component is P2 (=W2/V2) [W/m³], and the heat generation density of the third component is P3 (=W3/V3) [W/m³]. The heat generation density of the sixth component is P6 (=W6/V6) [W/m³].

Subsequently, the heat generation density determination section 24 determines whether or not the heat generation density P1 of the first component 101 calculated by the processing in S103 is greater than a predetermined heat generation density threshold value Py (S104). As an example, the heat generation density threshold value Py may have a default value of 2.1×10⁶ [W/m³] and may be changeable. When it is determined that the heat generation density P1 of the first component 101 is greater than the predetermined heat generation density threshold value Py (YES in S104), the heat generation density determination section 24 stores in the storage section 12 the first component 101 as the first heat dissipation measure component for which consideration of heat dissipation measures is desired (S105). For instance, when the heat generation density P1 of the first component 101 is 3.5×10⁶ [W/m³] and the heat generation density threshold value Py is 2.1×10⁶ [W/m³], the heat generation density determination section 24 determines that the heat generation density P1 is greater than the predetermined heat generation density threshold value Py (YES in S104). The heat generation density determination section 24 then stores in the storage section 12 the first component 101 as the first heat dissipation measure component for which consideration of heat dissipation measures is desired (S105). The heat generation density determination section 24 repeats the processing in S104 to S106 until it is determined that the determination processing in S104 has been performed on the second component 102, the third component 103 and the sixth component 106 each with a non-zero heat generation amount (YES in S106). For instance, when it is determined that the heat generation density P2 of the second component 102 is 2.5×10⁶ [W/m³] which is greater than the heat generation density threshold value Py (YES in S104), the second component 102 is stored in the storage section 12 as the first heat dissipation measure component for which consideration of heat dissipation measures is desired (S105). Also, when the heat generation density P3 of the third component 103 is 2.2×10⁶ [W/m³] which is greater than the heat generation density threshold value Py, the third component 103 is stored in the storage section 12 as the first heat dissipation measure component for which consideration of heat dissipation measures is desired (S105). Also, when the heat generation density P6 of the sixth component 106 is 4.5×10⁶ [W/m³] which is greater than the heat generation density threshold value Py (YES in S104), the sixth component 106 is stored in the storage section 12 as the first heat dissipation measure component for which consideration of heat dissipation measures is desired (S105).

When it is determined that the determination processing in S104 has been performed on all the components, each of which has a non-zero heat generation amount W (YES in S106), the heat dissipation consideration signal output section 25 outputs a heat dissipation consideration signal indicating that consideration of heat dissipation measures is desired for the first heat dissipation measure components stored in the storage section 12 (S107). As an example, as illustrated in FIG. 5E, an image corresponding to the heat dissipation consideration signal may include the component name, the heat generation density P, a determination result and a symbol indicating the determination result for each of the first components 101 to the third component 103 and the sixth component 106. The symbol indicating the determination result is displayed as “x” when consideration of heat dissipation measures is desired or displayed as “O” when consideration of heat dissipation measures is not desired.

### Configuration and Function of Information Processing Device According to Second Embodiment

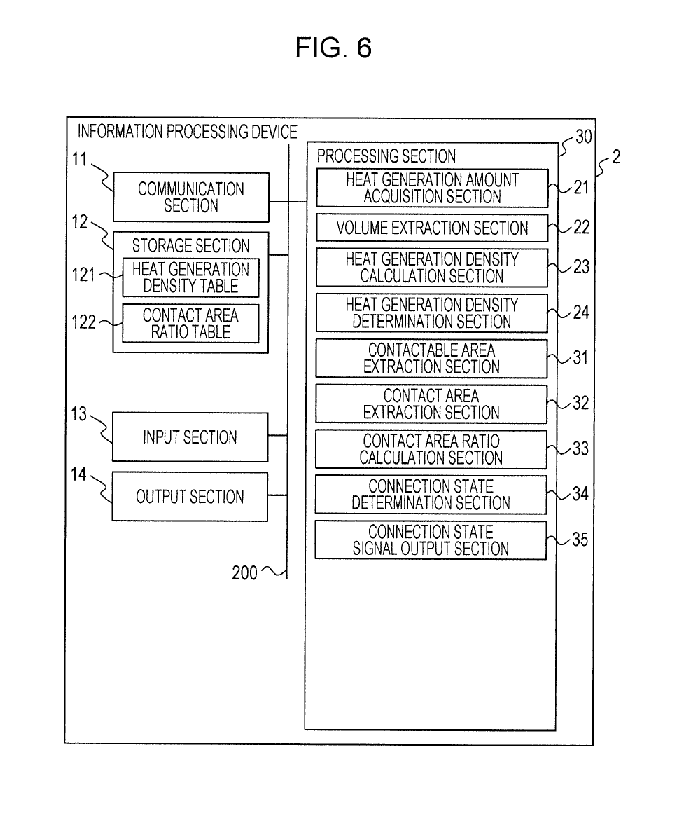

FIG. 6 is a diagram illustrating an information processing device according to a second embodiment.

An information processing device 2 differs from the information processing device 1 in that the information processing device 2 has a processing section 30 instead of the processing section 20. The configuration and function of constituent elements of the information processing device 2 excluding the processing section 30 are the same as the configuration and function of constituent elements labeled with the same symbol in the information processing device 1 except that the storage section 12 stores a contact area ratio table 122 in the information processing device 2, and thus a detailed description is omitted here.

The processing section 30 differs from the processing section 20 in that the processing section 30 has a contactable area extraction section 31, a contact area extraction section 32, a contact area ratio calculation section 33, a connection state determination section 34 and a connection state signal output section 35 instead of the heat dissipation consideration signal output section 25. The configuration and function of constituent elements of the processing section 30 excluding the contactable area extraction section 31 to the connection state signal output section 35 are the same as the configuration and function of constituent elements labeled with the same symbol in the processing section 20, and thus a detailed description is omitted here.

### Heat Dissipation Measure Determination Processing by Information Processing Device According to Second Embodiment

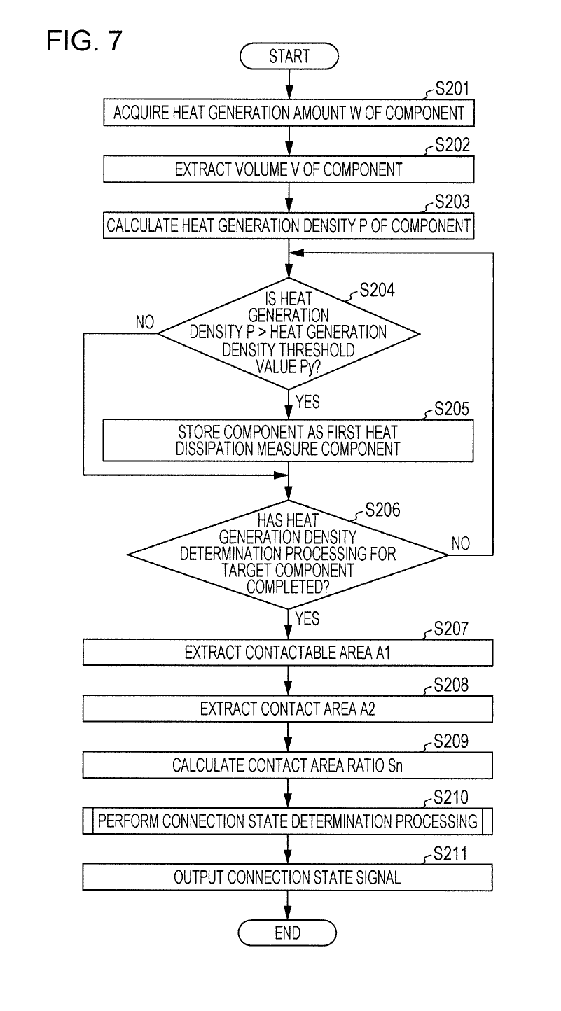

FIG. 7 is a flowchart of heat dissipation measure determination processing in the information processing device 2. The heat dissipation measure determination processing illustrated in FIG. 7 is performed mainly by the processing section 30 that cooperates with each element of the information processing device 2 based on a program pre-stored in the storage section 12.

The processing in S201 to S206 is the same as the processing in S101 to S106, and thus a detailed description is omitted here. When it is determined that the determination processing in S204 has been performed on all the components, each of which has a non-zero heat generation amount (YES in S206), the contactable area extraction section 31 extracts a contactable area A1 that indicates a contactable area between each of all components and each of other components mounted on the mounting substrate (S207). The contactable area extraction section 31 stores the extracted contactable area A1 in a contact area ratio table 122 in association with a component joining combination that indicates a thermal connection state between the components. Subsequently, the contact area extraction section 32 extracts a contact area A2 that indicates a contact area between each of all components and the other component mounted on the mounting substrate (S208), and stores the extracted contact area A2 in the contact area ratio table 122 in association with a component joining combination. Subsequently, the contact area ratio calculation section 33 calculates a contact area ratio Sn that indicates the ratio of the contact area A2 to the contactable area A1 (S209), and stores the calculated contact area ratio Sn in the contact area ratio table 122 in association with a component joining combination.

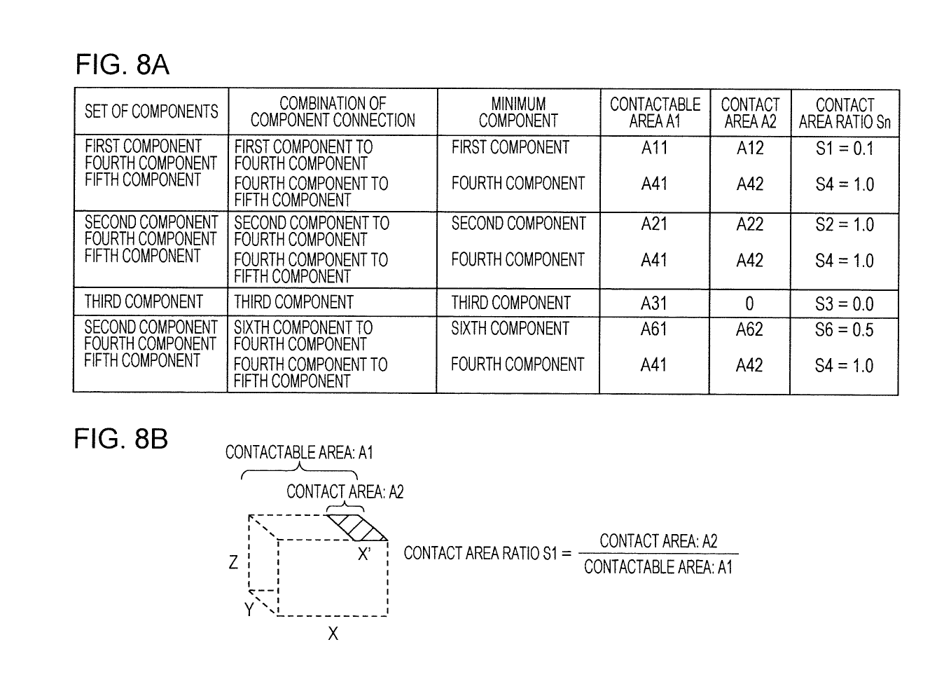

FIG. 8A is a diagram illustrating an example of the contact area ratio table 122 to be stored in the storage section 12, and FIG. 8B is a diagram for explaining the processing in S207 to S209.

The contact area ratio table 122 stores a component set that forms a heat dissipation path, a component joining combination that indicates a combination of components that are in contact with each other in a component path, and a minimum component that indicates which one of the components in the component joining combination has a smaller contactable area A1. In addition, the contact area ratio table 122 stores the contactable area A1, the contact area A2, and the contact area ratio Sn. The component set, the component joining combination and the minimum component may be extracted from analysis model data stored in the storage section 12 by the processing section 30, or may be specified in advance.

From an analysis model corresponding to analysis model data stored in the storage section 12, the contactable area extraction section 31 extracts the contactable area A1 (=X×Y) between each component and the other component from the width X, depth Y, and height Z of the components mounted on the mounting substrate. When the contactable areas of a component and the other component are different, the contactable area extraction section 31 adopts a smaller contactable area as the contactable area A1 that is used for calculation of a contact area ratio. It is to be noted that when the contactable areas of a component and the other component are the same, the contactable area extraction section 31 may adopt either one as the contactable area A1 that is used for calculation of a contact area ratio. From the analysis model, the contact area extraction section 32 extracts the contact area A2 (=X′×Y) between each component and the other component from the width X′ and contact depth Y of the component and the other component mounted on the mounting substrate. The contact area ratio calculation section 33 calculates the contact area ratio Sn by dividing the contact area A2 extracted from the contact area extraction section 32 by the contactable area A1 extracted from the contactable area extraction section 31.

Subsequently, the connection state determination section 34 determines a thermal connection state between the component and the other component based on the contact area ratio Sn (S210), and stores the determined connection state in the storage section 12. The connection state signal output section 35 then outputs a connection state signal that indicates the connection state determined by the connection state determination section 34 (S211).

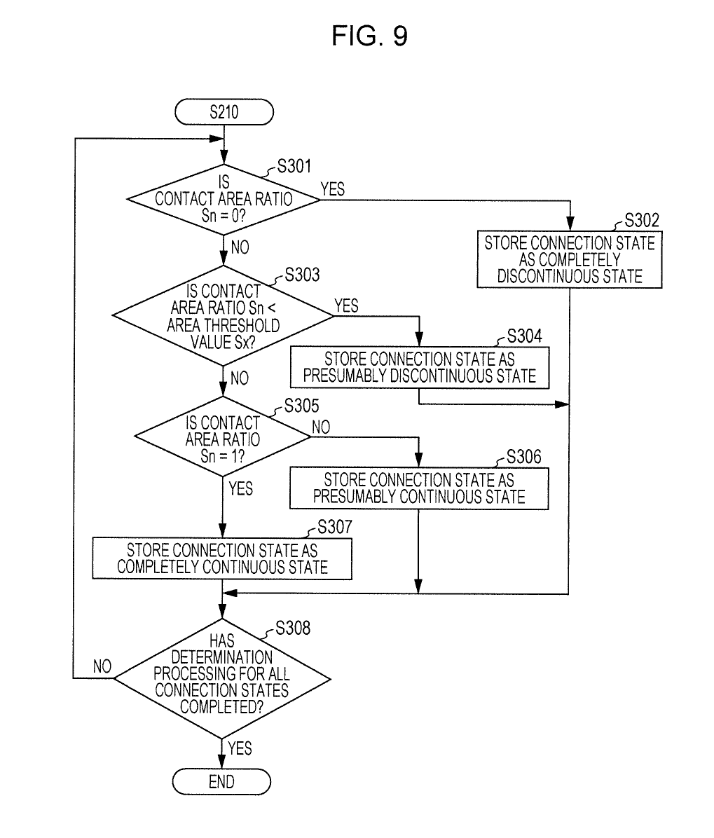

FIG. 9 is a flowchart illustrating more detailed processing in S210.

First, the connection state determination section 34 determines whether or not the contact area ratio Sn is 0 (S301). When it is determined that the contact area ratio Sn is 0 (YES in S301), the connection state determination section 34 stores completely discontinuous state in the storage section 12 as a connection state associated with the contact area ratio Sn, the completely discontinuous state indicating thermally not connected at all (S302). Subsequently, the connection state determination section 34 determines whether or not the connection state determination processing based on the contact area ratio Sn has been performed for all connection states (S308).

When it is determined that the contact area ratio Sn is not 0 (NO in S301), the connection state determination section 34 determines whether or not the contact area ratio Sn is less than a contact area threshold value Sx (S303). When it is determined that the contact area ratio Sn is less than the contact area threshold value Sx (YES in S303), the connection state determination section 34 stores presumably discontinuous state in the storage section 12 as a thermal connection state associated with the contact area ratio Sn, the presumably discontinuous state indicating relatively weak connection (S304). As an example, the contact area threshold value Sx may have a default value of 0.5 and may be changeable. Subsequently, the connection state determination section 34 determines whether or not the connection state determination processing based on the contact area ratio Sn has been performed for all connection states (S308).

When it is determined that the contact area ratio Sn is greater than or equal to the contact area threshold value Sx (NO in S303), the connection state determination section 34 determines whether or not the contact area ratio Sn is 1 (S305). When it is determined that the contact area ratio Sn is not 1 (NO in S305), the connection state determination section 34 stores presumably continuous state in the storage section 12 as a thermal connection state associated with the contact area ratio Sn, the presumably continuous state indicating relatively strong connection (S306). Subsequently, the connection state determination section 34 determines whether or not the connection state determination processing based on the contact area ratio Sn has been performed for all connection states (S308).

When it is determined that the contact area ratio Sn is 1 (YES in S305), the connection state determination section 34 stores a completely continuous state in the storage section 12, the completely continuous state indicating that the thermal connection state associated with the contact area ratio Sn is completely connected (S307). Subsequently, the connection state determination section 34 determines whether or not the connection state determination processing based on the contact area ratio Sn has been performed for all connection states (S308). The connection state determination section 34 repeats the processing in S301 to S308 until it is determined (S308) that the connection state determination processing based on the contact area ratio Sn has been performed for all connection states.

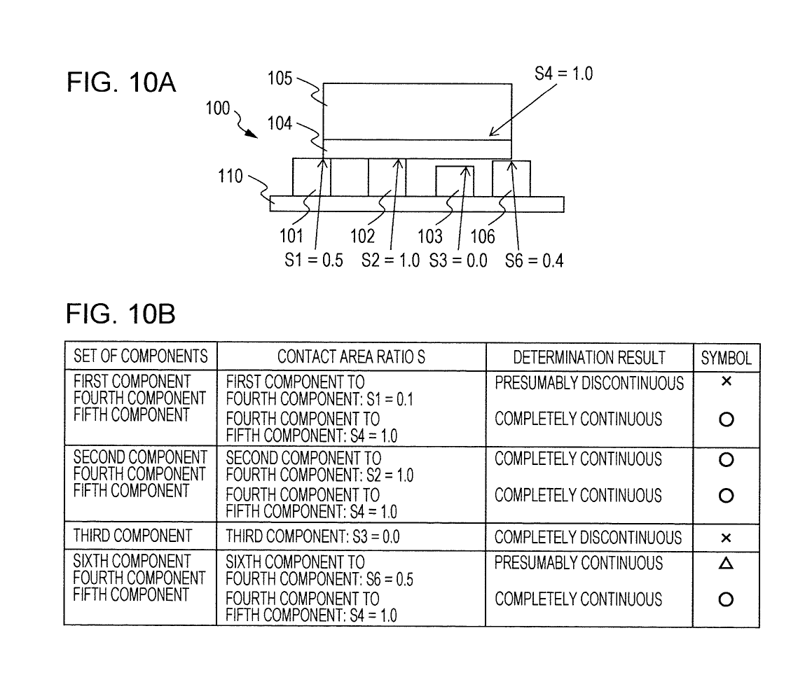

FIG. 10A is a diagram illustrating an example contact area ratio of the mounting substrate 100, and FIG. 10B is a diagram illustrating an example of an image corresponding to a heat dissipation consideration signal outputted by the processing in S211.

The processing in S207 to S211 performed by the information processing device 2 will be specifically described using the mounting substrate 100 as an example. First, the contactable area extraction section 31 extracts the contactable area A1 that indicates a contactable area between each of all components and the other component mounted on the mounting substrate (S207). When the contactable area A11 of the first component 101 with respect to the fourth component 104 is compared with the contactable area A41 of the fourth component 104 with respect to the first component 101, the contactable area A11 of the first component 101 with respect to the fourth component 104 is smaller. Since the contactable area A11 of the first component 101 with respect to the fourth component 104 is smaller, the contactable area A11 of the first component 101 with respect to the fourth component 104 is adopted as the contactable area A1 between the first component 101 and the fourth component 104. As an example, the contactable area A11 between the first component 101 and the fourth component 104 is 100 [m²]. Hereinafter, the contactable area extraction section 31 sequentially extracts contactable areas A21, A31 and A61 between the second component 102, the third component 103, the sixth component 106, respectively and the fourth component, as well as a contactable area A41 between the fourth component 104 and the fifth component 105.

Subsequently, the contact area extraction section 32 extracts the contact area A2 that indicates a contact area between each of all components and the other component mounted on the mounting substrate (S208). As an example, the contact area A12 between the first component 101 and the fourth component 104 is 10 [m²]. Hereinafter, the contact area extraction section 32 sequentially extracts contact areas A22, A32 and A62 between the second component 102, the third component 103, the sixth component 106, respectively and the fourth component, as well as a contact area A42 between the fourth component 104 and the fifth component 105.

Subsequently, the contact area ratio calculation section 33 calculates a contact area ratio Sn that indicates the ratio of the contact area A2 to the contactable area A1 (S209), and stores the calculated contact area ratio Sn in association with a thermal connection state between the components. When the contactable area A11 is 100 [m²] and the contact area A12 is 10 [m²], the contact area ratio S1 between the first component 101 and the fourth component 104 is calculated as (S1=A12/A11=10/100=0.1). Hereinafter, the contact area extraction section 32 sequentially extracts the contact area ratios S2, S3, S6 between the second component 102, the third component 103, the sixth component 106, respectively and the fourth component, and a contact area ratio S4 between the fourth component 104 and the fifth component 105. The contact area ratio S2 between the second component 102 and the fourth component 104 is 1.0, the contact area ratio S3 between the third component 103 and the fourth component 104 is 0.0, and the contact area ratio S6 between the sixth component 106 and the fourth component 104 is 0.5. The contact area ratio S4 between the fourth component 104 and the fifth component 105 is 1.0.

Subsequently, the connection state determination section 34 determines a connection state between the component and the other component based on the contact area ratio Sn (S210), and stores the determined connection state. Since the contact area ratio S1 between the first component 101 and the fourth component 104 is 0.1, which indicates a relationship of 0<S1 <Sx=0.5, the connection state determination section 34 determines that the thermal connection state between the first component 101 and the fourth component 104 is presumably discontinuous. Since the contact area ratio S2 between the second component 102 and the fourth component 104 is 1.0, the connection state determination section 34 determines that the thermal connection state between the second component 102 and the fourth component 104 is completely continuous. Since the contact area ratio S3 between the third component 103 and the fourth component 104 is 0.0, the connection state determination section 34 determines that the thermal connection state between the third component 103 and the fourth component 104 is completely discontinuous. Since the contact area ratio S6 between the sixth component 106 and the fourth component 104 is 0.5, which indicates a relationship of Sx=0.5<S6<1.0, the connection state determination section 34 determines that the thermal connection state between the sixth component 106 and the fourth component 104 is presumably continuous. Since the contact area ratio S4 between the fourth component 104 and the fifth component 105 is 1.0, the connection state determination section 34 determines that the thermal connection state between the fourth component 104 and the fifth component 105 is completely continuous.

The connection state signal output section 35 then outputs a connection state signal that indicates the connection state determined by the connection state determination section 34 (S211). As an example, as illustrated in FIG. 10B, an image corresponding to the connection state signal may include a component set that forms a heat dissipation path, a contact area ratio S, a determination result, and a symbol indicating the determination result. The symbol indicating the determination result is displayed as “x” when the thermal connection state is completely discontinuous or presumably discontinuous or displayed as “O” when the thermal connection state is completely continuous or presumably continuous.

### Configuration and Function of Information Processing Device According to Third Embodiment

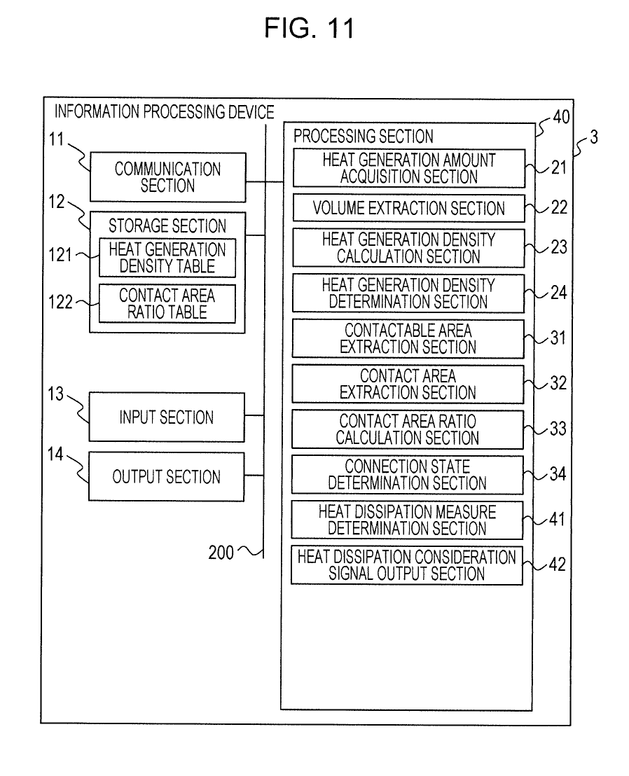

FIG. 11 is a diagram illustrating an information processing device according to a third embodiment.

The information processing device 3 differs from the information processing device 2 in that a processing section 40 is disposed instead of the processing section 30 in the information processing device 3. The configuration and function of constituent elements of the information processing device 3 excluding the processing section 40 are the same as the configuration and function of constituent elements labeled with the same symbol in the information processing device 2, and thus a detailed description is omitted here.

The processing section 40 differs from the processing section 30 in that processing section 40 has a heat dissipation measure determination section 41 and a heat dissipation consideration signal output section 42 instead of the connection state signal output section 35. The configuration and function of constituent elements of the processing section 40 excluding the heat dissipation measure determination section 41 and the heat dissipation consideration signal output section 42 are the same as the configuration and function of constituent elements labeled with the same symbol in the processing section 30, and thus a detailed description is omitted here.

### Heat Dissipation Measure Determination Processing by Information Processing Device According to Third Embodiment

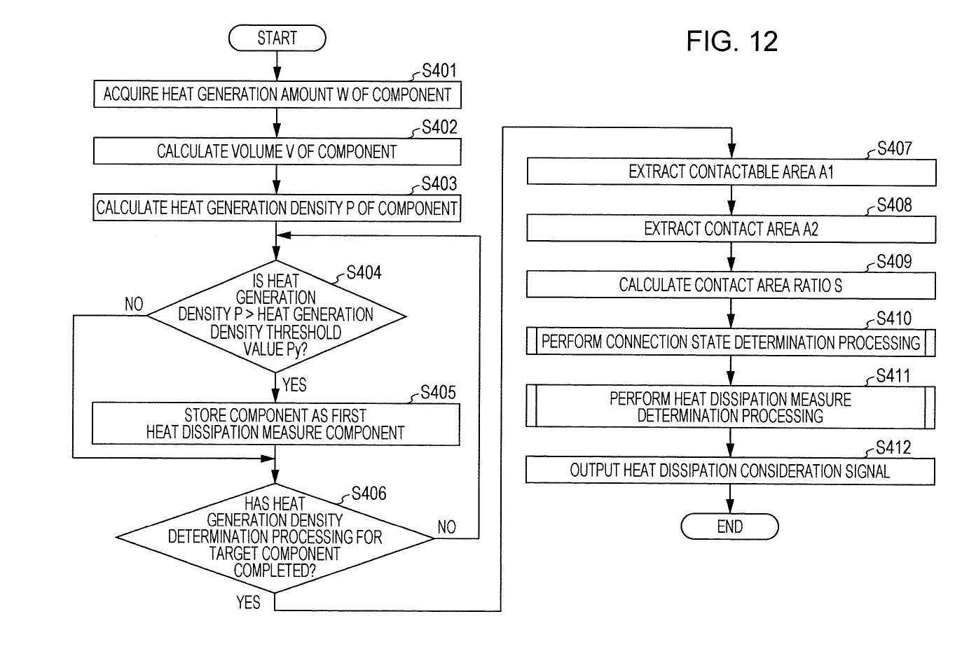

FIG. 12 is a flowchart of heat dissipation measure determination processing in the information processing device 3. The heat dissipation measure determination processing illustrated in FIG. 12 is performed mainly by the processing section 40 that cooperates with each element of the information processing device 3 based on a program pre-stored in the storage section 12.

The processing in S401 to S410 is the same as the processing in S201 to S210, and thus a detailed description is omitted here. The heat dissipation measure determination section 41 determines whether or not consideration of heat dissipation measures is desired for the component based on the heat generation density P calculated by the processing in S403 and the thermal connection state determined by the processing in S410 (S411). The heat dissipation measure determination section 41 stores a component for which consideration of heat dissipation measures is determined to be desired, as a second heat dissipation measure component. The heat dissipation consideration signal output section 42 then outputs a heat dissipation consideration signal indicating that consideration of heat dissipation measures is desired for a component which is determined to be the second heat dissipation measure component by the heat dissipation measure determination section 41 (S412).

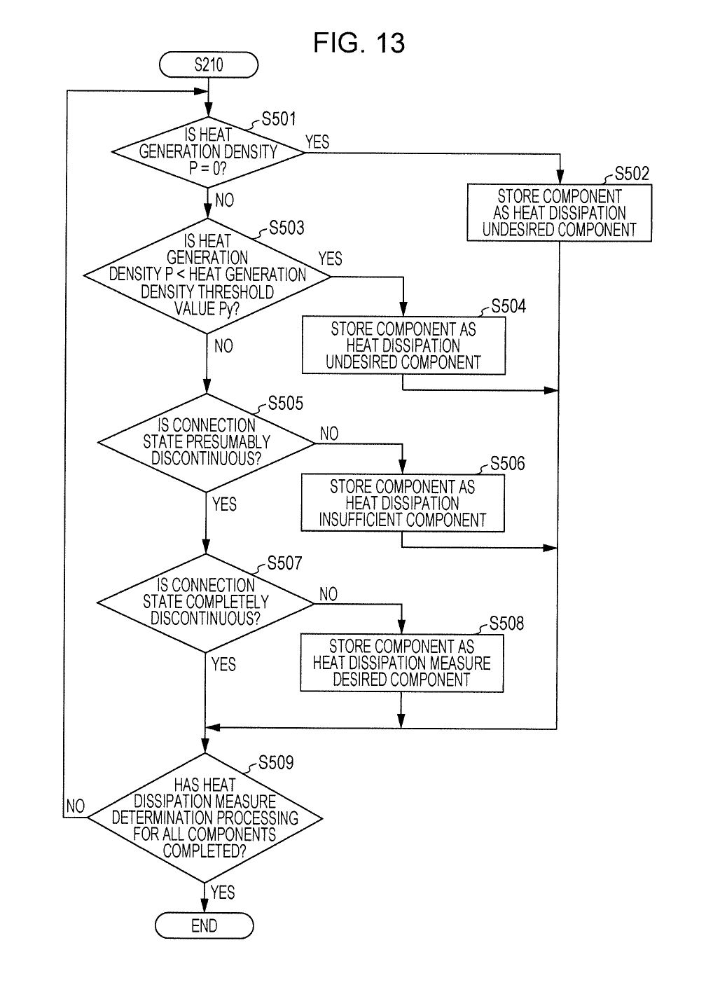

FIG. 13 is a flowchart illustrating more detailed processing in S411.

First, the heat dissipation measure determination section 41 determines whether or not the heat generation density P of the component is 0 (S501). When it is determined that the heat generation density P of the component is 0 (YES in S501), the heat dissipation measure determination section 41 determines that the component is a heat receiving body, and stores a heat dissipation undesirable state of the component in the storage section 12 (S502). Subsequently, the heat dissipation measure determination section 41 determines whether or not the heat dissipation measure determination processing has been performed on all the components (S509).

When it is determined that the heat generation density P of the component is not 0 (NO in S501), the heat dissipation measure determination section 41 determines whether or not the heat generation density P of the component is less than the heat generation density threshold value Py (S503). When it is determined that the heat generation density P of the component is less than the heat generation density threshold value Py (YES in S503), the heat dissipation measure determination section 41 stores a heat dissipation undesirable state of the component in the storage section 12 (S504). In other words, the heat dissipation measure determination section 41 determines that heat dissipation is not desired for a component in which the heat generation density P is less than the heat generation density threshold value and (∩) which is presumably discontinuous. It is to be noted that the heat dissipation measure determination section 41 determines whether or not the heat generation density of the component is in the vicinity of the heat generation density threshold value with a varied heat generation density threshold value, and when the heat generation density of the component is in the vicinity of the heat generation density threshold value, it is preferable to determine that the component is heat dissipation potentially insufficient. Subsequently, the heat dissipation measure determination section 41 determines whether or not the heat dissipation measure determination processing has been performed on all the components (S509).

When it is determined that the heat generation density P of the component is greater than or equal to the heat generation density threshold value Py (NO in S503), the heat dissipation measure determination section 41 determines whether or not the thermal connection state of the component is presumably discontinuous (S505). When it is determined that the thermal connection state of the component is presumably discontinuous (YES in S505), the heat dissipation measure determination section 41 stores a heat dissipation insufficient state of the component in the storage section 12 (S506). In other words, the heat dissipation measure determination section 41 determines that heat dissipation is insufficient for a component in which the heat generation density P is greater than or equal to the heat generation density threshold value Py and (∩) the thermal connection state is presumably discontinuous because heat transfer to other components is not sufficient. Subsequently, the heat dissipation measure determination section 41 determines whether or not the heat dissipation measure determination processing has been performed on all the components (S509).

When it is determined that the thermal connection state of the component is not presumably discontinuous (NO in S505), the heat dissipation measure determination section 41 determines whether or not the thermal connection state of the component is completely discontinuous (S507). When it is determined that the thermal connection state of the component is completely discontinuous (YES in S507), the heat dissipation measure determination section 41 stores a heat dissipation consideration desirable state of the component in the storage section 12 (S508). In other words, the heat dissipation measure determination section 41 determines that consideration of heat dissipation is desired for a component in which the heat generation density P is greater than or equal to the heat generation density threshold value Py and (∩) the thermal connection state is completely discontinuous because no heat is transferred to other components. Subsequently, the heat dissipation measure determination section 41 determines whether or not the heat dissipation measure determination processing has been performed on all the components (S509). The heat dissipation measure determination section 41 repeats the processing in S501 to S509 until it is determined (S509) that the heat dissipation measure determination processing has been performed on all the components.

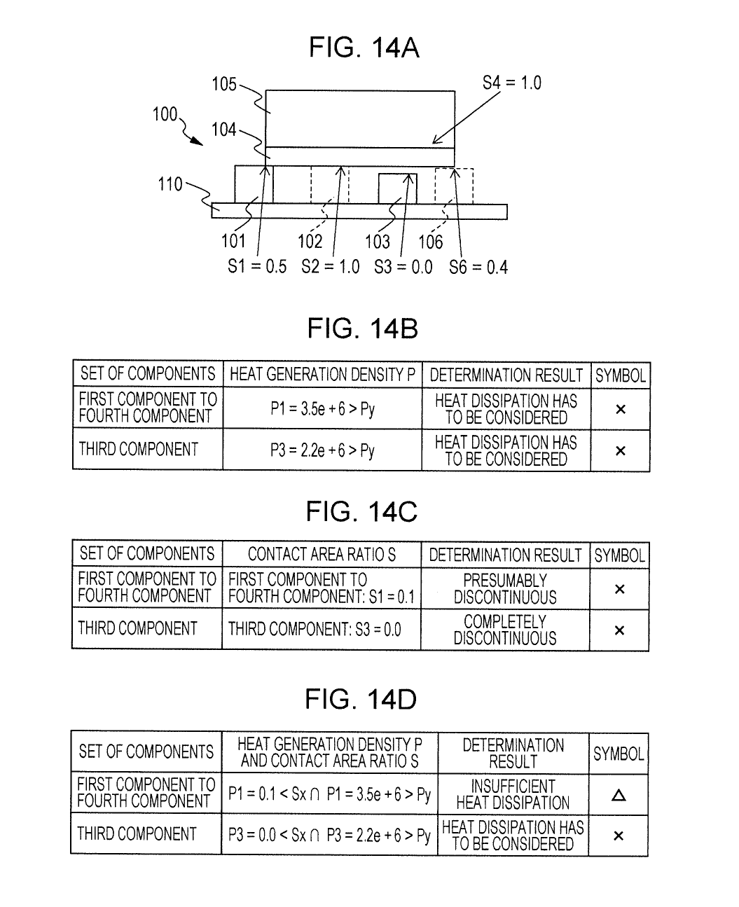

FIG. 14A is a diagram illustrating an example determination result of the heat dissipation measure determination processing on the mounting substrate 100 made by the information processing device 3. FIG. 14B is a table illustrating a relationship between heat generation density and determination result made by the heat dissipation measure determination processing, and FIG. 14C is a table illustrating a relationship between thermal connection state of components and determination result made by the heat dissipation measure determination processing. FIG. 14D is a diagram illustrating an example image corresponding to a heat dissipation consideration signal outputted by the processing in S412.

The processing in S411 and S412 performed by the information processing device 3 will be specifically described using the mounting substrate 100 as an example. The heat dissipation measure determination section 41 determines whether or not consideration of heat dissipation measures is desired for the component based on the heat generation density P calculated by the processing in S403 and the thermal connection state determined by the processing in S410 (S411).

As illustrated in FIG. 14B, since the heat generation density P1 of the first component 101 is 3.5×10⁶ [W/m³] which is greater than 2.1×10⁶ [W/m³] that is the heat generation density threshold value Py, the heat dissipation measure determination section 41 determines that the first component 101 is the second heat dissipation measure component for which consideration of heat dissipation measures is desired. Also, since the heat generation density P3 of the third component 103 is 2.2×10⁶ [W/m³] which is greater than 2.1×10⁶ [W/m³] that is the heat generation density threshold value Py, the heat dissipation measure determination section 41 determines that the third component 103 is the second heat dissipation measure component for which consideration of heat dissipation measures is desired.

As illustrated in FIG. 14C, since the contact area ratio S1 between the first component 101 and the fourth component 104 is 0.1, which indicates a relationship of 0<S1<Sx=0.5, the heat dissipation measure determination section 41 determines that the state between the first component 101 and the fourth component 104 is presumably discontinuous. Since the contact area ratio S3 between the third component 103 and the fourth component 104 is 0.0, the heat dissipation measure determination section 41 determines that the state between the third component 103 and the fourth component 104 is completely discontinuous.

The heat dissipation consideration signal output section 42 then outputs a heat dissipation consideration signal indicating that consideration of heat dissipation measures is desired for a component which is determined to be the second heat dissipation measure component (S412). As an example, as illustrated in FIG. 14D, an image corresponding to the heat dissipation consideration signal may include a component set for which heat dissipation measures are considered, a heat generation density P, a contact area ratio S, a determination result, and a symbol indicating the determination result. The symbol indicating the determination result is displayed as “x” when consideration of heat dissipation measures is desired, or displayed as “Δ” when heat dissipation is insufficient, or displayed as “O” when heat dissipation is not desired.

### Configuration and Function of Information Processing Device According to Fourth Embodiment

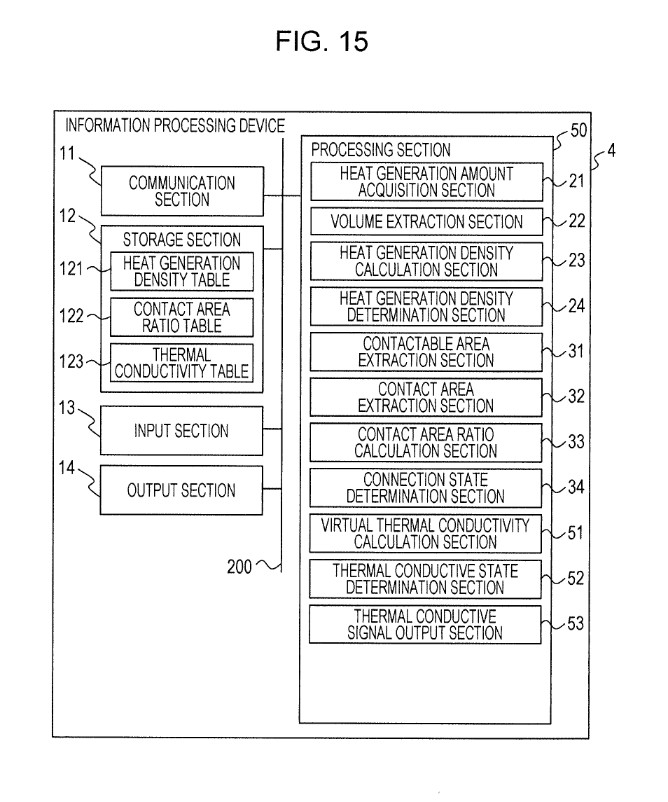

FIG. 15 is a diagram illustrating an information processing device according to a fourth embodiment.

The information processing device 4 differs from the information processing device 2 in that the information processing device 4 has a processing section 50 instead of the processing section 30. The configuration and function of constituent elements of the information processing device 4 excluding the processing section 50 are the same as the configuration and function of constituent elements labeled with the same symbol in the information processing device 2 except that the storage section 12 stores a thermal conductivity table 123 in the information processing device 4, and thus a detailed description is omitted here.

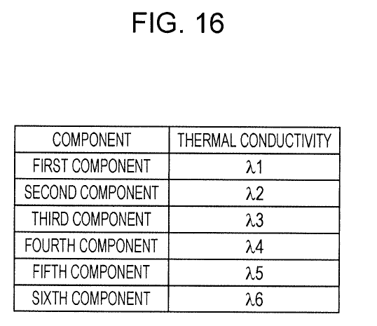

FIG. 16 is a diagram illustrating an example of a thermal conductivity table 123 to be stored in the storage section 12.

The thermal conductivity table 123 stores the thermal conductivity of each of the components mounted on a mounting substrate. As an example, the thermal conductivity of the first component 101 is λ1 [W/(m·K)], the thermal conductivity of the second component 102 is λ2 [W/(m·K)], and the thermal conductivity of the third component 103 is λ3 [W/(m·K)]. Also, the thermal conductivity of the fourth component 104 is λ4 [W/(m·K)], the thermal conductivity of the fifth component 105 is λ5 [W/(m·K)], and the thermal conductivity of the sixth component 106 is λ6 [W/(m·K)].

The processing section 50 differs from the processing section 30 in that processing section 50 has a virtual thermal conductivity calculation section 51, a thermal conductive state determination section 52 and a heat dissipation consideration signal output section 53 instead of the connection state signal output section 35. The configuration and function of constituent elements of the processing section 50 excluding the virtual thermal conductivity calculation section 51, the thermal conductive state determination section 52 and the heat dissipation consideration signal output section 53 are the same as the configuration and function of constituent elements labeled with the same symbol in the processing section 30, and thus a detailed description is omitted here.

### Heat Dissipation Measure Determination Processing by Information Processing Device According to Fourth Embodiment

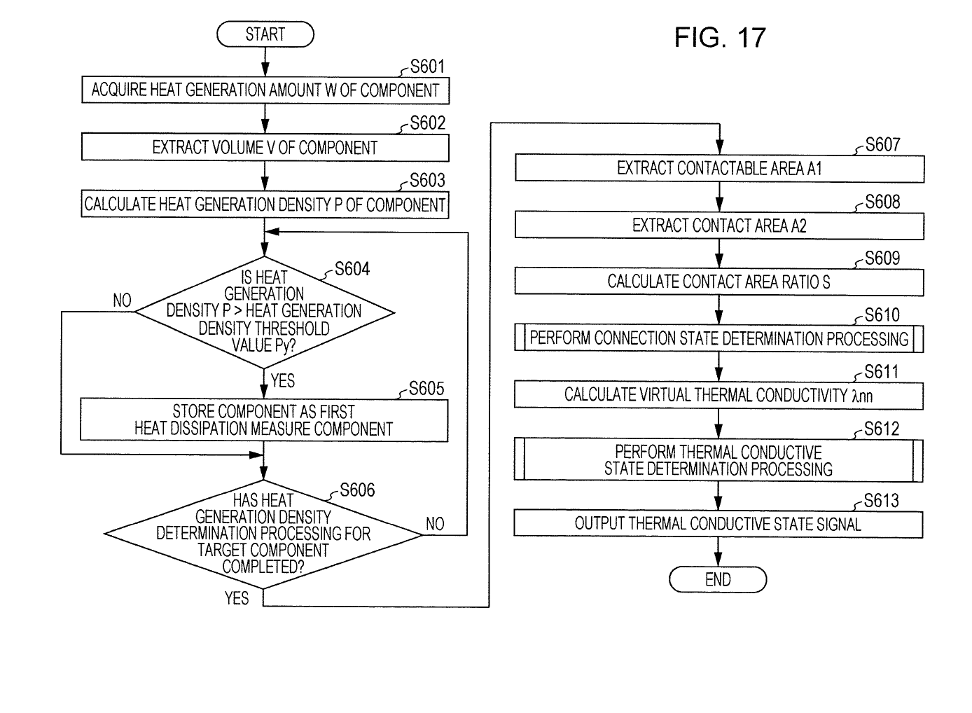

FIG. 17 is a flowchart of heat dissipation measure determination processing in the information processing device 4. The heat dissipation measure determination processing illustrated in FIG. 17 is performed mainly by the processing section 50 that cooperates with each element of the information processing device 4 based on a program pre-stored in the storage section 12.

The processing in S601 to S610 is the same as the processing in S201 to S210, and thus a detailed description is omitted here. The virtual thermal conductivity calculation section 51 calculates a virtual thermal conductivity λnn (S611) that indicates a thermal conductivity between a component and the other component, the component being different from any component with a thermal connection state determined to be completely continuous by the processing in S610, and stores the calculated virtual thermal conductivity λnn in the storage section 12. In other words, the virtual thermal conductivity calculation section 51 calculates a virtual thermal conductivity λnn that indicates a thermal conductivity between a component and the other component, the component with a thermal connection state determined to be completely discontinuous, presumably discontinuous, or presumably continuous by the processing in S610. As an example, the virtual thermal conductivity λnn is calculated by multiplying together (λnn=λn×Sn) the thermal conductivity λn and the contact area ratio Sn of one of the component mounted on the mounting substrate and the other component mounted on the mounting substrate. When the virtual thermal conductivity λnn is calculated, the virtual thermal conductivity calculation section 51 adopts the smaller one of the thermal conductivities λn of the components in contact with each other as the thermal conductivity λn used for calculation of the virtual thermal conductivity λnn. For instance, when the thermal conductivity λ1 of the first component 101 including a resin is 0.2, and the thermal conductivity λ4 of the fourth component 104, which is a TIM in contact with the first component 101, is 3.5, (λ1<λ4) holds. Since (λ1<λ4), the virtual thermal conductivity calculation section 51 adopts the thermal conductivity λ1 of the first component 101 as the thermal conductivity λn used for calculation of the virtual thermal conductivity λnn.

Subsequently, the thermal conductive state determination section 52 determines a thermal conductive state (S612) of the component based on the virtual thermal conductivity λnn calculated by the processing in S611, and stores the determined thermal conductive state in association with the component name. The heat dissipation consideration signal output section 53 then outputs a thermal conductive state signal indicating a thermal conductive state (S613).

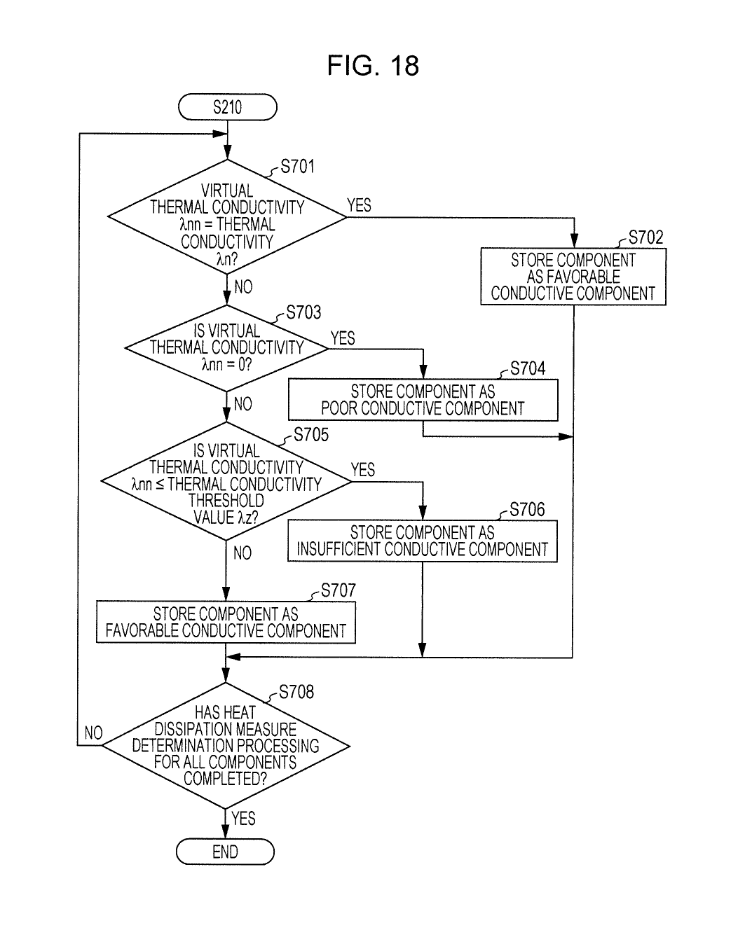

FIG. 18 is a flowchart illustrating more detailed processing in S612.

First, the thermal conductive state determination section 52 determines whether or not the thermal conductivity used for calculation of the virtual thermal conductivity λnn matches the virtual thermal conductivity λnn between the component with a thermal connection state determined to be completely discontinuous, presumably discontinuous, or presumably continuous by the processing in S610 and the other component (S701). When it is determined that the virtual thermal conductivity λnn between the component and the other component matches the thermal conductivity used for calculation of the virtual thermal conductivity λnn (YES in S701), the thermal conductive state determination section 52 stores a favorable thermal conductive state of the component in the storage section 12 (S702). Subsequently, the thermal conductive state determination section 52 determines whether or not the heat dissipation measure determination processing has been performed on all the components with a thermal connection state determined to be completely discontinuous, presumably discontinuous, or presumably continuous by the processing in S610 (S708).

When it is determined that the virtual thermal conductivity λnn between the component and the other component does not match the smaller one of the thermal conductivities of the component and the other component (NO in S701), the thermal conductive state determination section 52 determines whether or not the virtual thermal conductivity λnn between the component and the other component is 0 (S703). When it is determined that the virtual thermal conductivity λnn between the component and the other component is 0 (YES in S703), the thermal conductive state determination section 52 stores a poor thermal conductive state of the component in the storage section 12 (S504). Subsequently, the thermal conductive state determination section 52 determines whether or not the heat dissipation measure determination processing has been performed on all the components with a thermal connection state determined to be completely discontinuous, presumably discontinuous, or presumably continuous by the processing in S610 (S708).

When it is determined that the virtual thermal conductivity λnn between the component and the other component is not 0 (NO in S703), the thermal conductive state determination section 52 determines whether or not the virtual thermal conductivity λnn between the component and the other component is less than or equal to a thermal conductive threshold value λz (S705). As an example, the thermal conductive threshold value λz may have a default value of 0.1 [W/(mK)] and may be changeable. When it is determined that the virtual thermal conductivity λnn between the component and the other component is less than or equal to the thermal conductive threshold value λz (YES in S705), the thermal conductive state determination section 52 stores an insufficient thermal conductive state of the component in the storage section 12 (S706). Subsequently, the thermal conductive state determination section 52 determines whether or not the heat dissipation measure determination processing has been performed on all the components with a thermal connection state determined to be completely discontinuous, presumably discontinuous, or presumably continuous by the processing in S610 (S708).

When it is determined that the virtual thermal conductivity λnn between the component and the other component is greater than the thermal conductive threshold value λz (NO in S705), the thermal conductive state determination section 52 stores a favorable thermal conductive state of the component in the storage section 12 (S707). Subsequently, the thermal conductive state determination section 52 determines whether or not the heat dissipation measure determination processing has been performed on all the components (S708). The thermal conductive state determination section 52 repeats the processing in S701 to S708 until it is determined (S708) that the heat dissipation measure determination processing has been performed on all the components with a thermal connection state determined to be completely discontinuous, presumably discontinuous, or presumably continuous by the processing in S610.

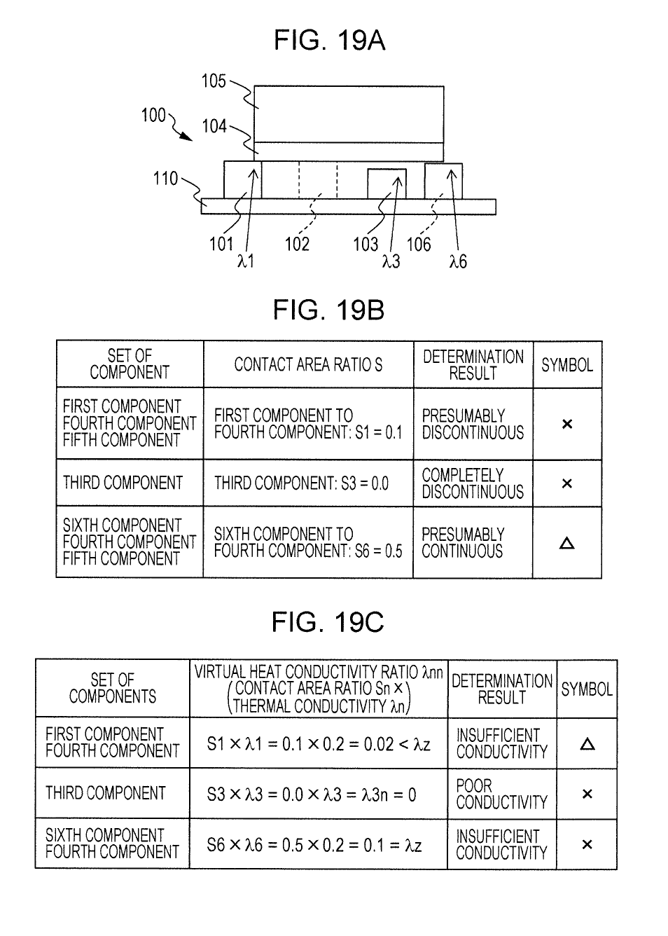

FIG. 19A is a diagram illustrating an example component that is a target component on which thermal conductive state determination processing is performed, and FIG. 19B is a diagram illustrating an example determination result as to the thermal connection state of a target component on which thermal conductive state determination processing is performed. FIG. 19C is a diagram illustrating an example image corresponding to a thermal conductive state signal outputted by the processing in S613.

The processing in S611 to S613 performed by the information processing device 4 will be specifically described using the mounting substrate 100 as an example. The virtual thermal conductivity calculation section 51 calculates a virtual thermal conductivity λnn that indicates a thermal conductivity between a component and the other component, the component with a thermal connection state determined to be completely discontinuous, presumably discontinuous, or presumably continuous by the processing in S610 (S611). The virtual thermal conductivity calculation section 51 refers to the contact area ratio table 122 stored in the storage section 12, and extracts a thermal connection state between the component and the other component in the mounting substrate 100, the component with a thermal connection state determined to be completely discontinuous, presumably discontinuous, or presumably continuous by the processing in S610. As illustrated in FIG. 19B, the virtual thermal conductivity calculation section 51 extracts a thermal connection state between the first component 101 and the fourth component 104, and thermal connection states between the third component, the sixth component 106, respectively and the fourth component 104. On the other hand, a thermal connection state between the second component 102 and the fourth component 104, illustrated by a dashed line in FIG. 19A is completely continuous, and thus is not extracted.

The virtual thermal conductivity calculation section 51 calculates a virtual thermal conductivity λ1n (=S1×λ1=0.1×0.2=0.02) between the first component 101 and the fourth component by multiplying the contact area ratio S1 between the first component 101 and the fourth component by the thermal conductivity λ1 of the first component 101. The virtual thermal conductivity calculation section 51 calculates a virtual thermal conductivity λ3n (=S3×λ3=0.0×λ3=0) between the third component 103 and the fourth component by multiplying the contact area ratio S3 between the third component 103 and the fourth component by the thermal conductivity λ3 of the third component 103. The virtual thermal conductivity calculation section 51 calculates a virtual thermal conductivity λ6n (=S6×λ6=0.5×0.2=0.1) between the sixth component 106 and the fourth component by multiplying the contact area ratio S6 between the sixth component 106 and the fourth component by the thermal conductivity λ6 of the sixth component 106.

Subsequently, the thermal conductive state determination section 52 determines a thermal conductive state of the component based on the virtual thermal conductivity λnn calculated by the processing in S611 (S612). Since the virtual thermal conductivity λ1n between the first component 101 and the fourth component 104 is 0.02, which is smaller than the thermal conductivity threshold value 0.1, the thermal conductive state determination section 52 determines that the conductivity is insufficient (S706). Since the virtual thermal conductivity λ3n between the third component 103 and the fourth component 104 is 0, the thermal conductive state determination section 52 determines that the conductivity is poor (S704). Since the virtual thermal conductivity λ1n between the sixth component 106 and the fourth component 104 is 0.1 which is equal to the thermal conductivity threshold value 0.1, the thermal conductive state determination section 52 determines that the conductivity is insufficient (S706).

The heat dissipation consideration signal output section 53 outputs a thermal conductive state signal indicating a thermal conductive state (S613). As an example, as illustrated in FIG. 19C, an image corresponding to the thermal conductive state signal may include a component set for which heat dissipation measures are considered, the virtual thermal conductivity λnn calculated by multiplying together the contact area ratio Sn and the thermal conductivity λn, a determination result, and a symbol indicating the determination result. The symbol indicating the determination result is displayed as “x” when the conductivity is poor, or displayed as “Δ” when the conductivity is insufficient, or displayed as “O” when the conductivity is favorable.

### Operational Effect of Information Processing Device According to Embodiments

The information processing device according to the embodiments determines desirability of consideration of heat dissipation measures using a heat generation density, thereby making it possible to determine desirability heat dissipation measures for a component with a small heat generation amount and a small size without fail.

In addition, since the information processing device according to the embodiments determines a thermal connection state between any two of the components mounted on a mounting substrate based on the contact area ratio, and a designer does not have to visually determine a thermal connection state between the components, and thus the time and effort of the designer may be reduced.

In addition, the information processing device according to the embodiments determines desirability of consideration of heat dissipation measures based on a heat generation density and a contact area ratio, thereby making it possible to determine desirability of heat dissipation measures with high accuracy.

The information processing device according to the embodiments determines a thermal conductivity between any two of the components mounted on a mounting substrate using a virtual thermal conductivity, thereby making it possible to extract connections between components with a poor thermal conductivity without fail.

### Modifications of Information Processing Device According to Embodiments

Although the information processing devices 1 to 4 determine desirability of consideration of heat dissipation measures using a heat generation density, the information processing device according to the embodiments may determine desirability of consideration of heat dissipation measures using a parameter which is other than the heat generation density and which varies with the size of a component. For instance, the information processing device according to the embodiments may determine desirability of consideration of heat dissipation measures using a heat generation amount per unit area as a parameter.

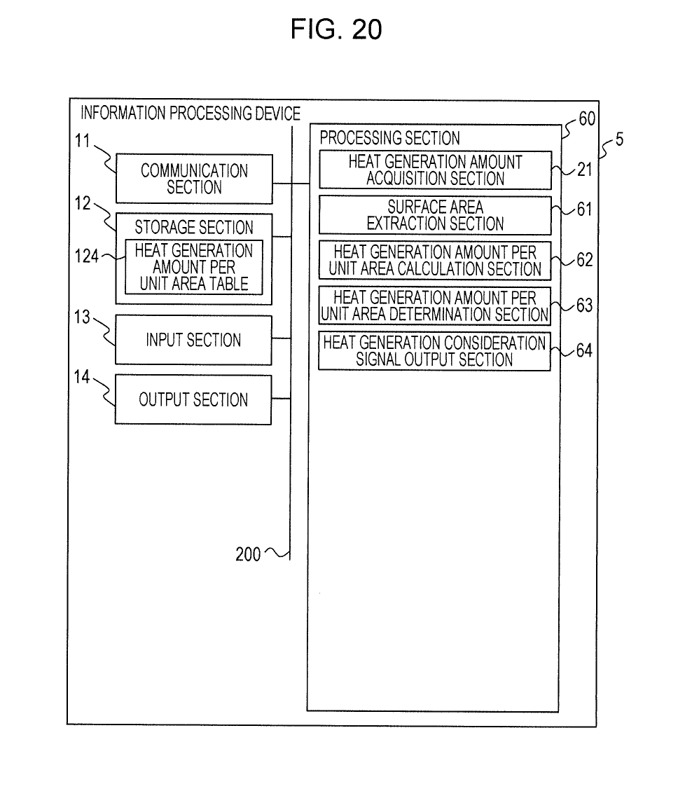

FIG. 20 is a diagram illustrating an information processing device according to a fifth embodiment.

The information processing device 5 differs from the information processing device 1 in that the information processing device 5 has a processing section 60 instead of the processing section 20. The configuration and function of constituent elements of the information processing device 5 excluding the processing section 60 are the same as the configuration and function of constituent elements labeled with the same symbol in the information processing device 1 except that the storage section 12 stores a heat generation amount per unit area table 124 instead of the heat generation density table 121 in the information processing device 5, and thus a detailed description is omitted here.

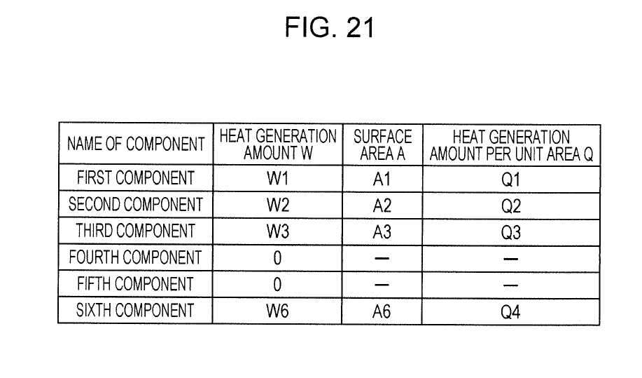

FIG. 21 is a diagram illustrating an example of the heat generation amount per unit area table 124 to be stored in the storage section 12.

The heat generation amount per unit area table 124 stores the heat generation amount W, the surface area A, and a heat generation amount per unit area Q obtained by dividing the heat generation amount W by the surface area A of each of the components mounted on a mounting substrate. The heat generation amount per unit area Q of the first component 101 with a heat generation amount W of W1 and a surface area A of A1 is Q1 (=W1/A1) [W/m²]. The heat generation amount per unit area Q of the second component 102 with a heat generation amount W of W2 and a surface area A of A2 is Q2 (=W2/A2) [W/m²]. The heat generation amount per unit area Q of the third component 103 with a heat generation amount W of W3 and a surface area A of A3 is Q3 (=W3/A3) [W/m²]. The heat generation amount per unit area Q of the sixth component 106 with a heat generation amount W of W6 and a surface area A of A6 is Q6 (=W6/A6) [W/m²].

The processing section 60 differs from the processing section 20 in that processing section 60 has a surface area extraction section 61, a heat generation amount per unit area calculation section 62, a heat generation amount per unit area determination section 63 and a heat dissipation consideration signal output section 64 instead of the volume extraction section 22 to the heat dissipation consideration signal output section 25. The configuration and function of constituent elements of the processing section 60 excluding the surface area extraction section 61 to the heat dissipation consideration signal output section 64 are the same as the configuration and function of constituent elements labeled with the same symbol in the processing section 20, and thus a detailed description is omitted here.

### Heat Dissipation Measure Determination Processing by Information Processing Device According to Fifth Embodiment

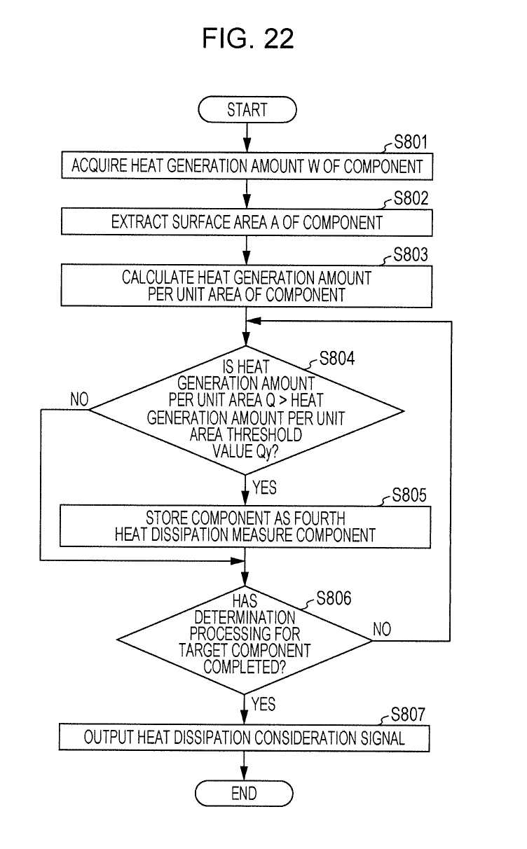

FIG. 22 is a flowchart of heat dissipation measure determination processing in the information processing device 5. The heat dissipation measure determination processing illustrated in FIG. 22 is performed mainly by the processing section 60 that cooperates with each element of the information processing device 5 based on a program pre-stored in the storage section 12.

First, the heat generation amount acquisition section 21 acquires the heat generation amount W of each component mounted on a substrate (S801), and stores the heat generation amount W in the heat generation amount per unit area table 124 in association with the component name. Subsequently, the surface area extraction section 61 extracts the surface area of a component with a heat generation amount greater than 0, that is, a component with a non-zero heat generation amount (S802), and stores the extracted surface area A in the heat generation amount per unit area table 124 in association the component name and the heat generation amount W. Subsequently, the heat generation amount per unit area calculation section 62 calculates the heat generation amount per unit area Q of each component with a non-zero heat generation amount W using the heat generation amount W and the surface area A of the component stored in the heat generation amount per unit area table 124 (S803). Subsequently, the heat generation amount per unit area determination section 63 determines whether or not the heat generation amount per unit area Q calculated by the processing in S803 is greater than a predetermined heat generation amount per unit area threshold value Qy (S804). When it is determined that the heat generation amount per unit area Q is greater than the predetermined heat generation amount per unit area threshold value Qy (YES in 804), the heat generation amount per unit area determination section 63 stores the component in the storage section 12 as a fourth heat dissipation measure component for which consideration of heat dissipation measures is desired (S805). The heat generation amount per unit area determination section 63 determines whether or not the determination processing in 804 has been performed on all the components each of which is stored in the heat generation amount per unit area table 124 and which has a non-zero heat generation amount (S806). The heat generation amount per unit area determination section 63 repeats the processing in S804 to S806 until it is determined (YES in S806) that the determination processing in 804 has been performed on all the components each of which is stored in the heat generation amount per unit area table 124 and which has a non-zero heat generation amount. When it is determined that the determination processing in 804 has been performed on all the components each of which has a non-zero heat generation amount (YES in S806), the heat dissipation consideration signal output section 64 outputs a heat dissipation consideration signal indicating that consideration of heat dissipation measures is desired for the fourth heat dissipation measure components stored in the storage section 12 (S807).

Also, although an output signal such as a heat dissipation consideration signal is a signal indicating a table that lists character information in the information processing devices 1 to 5, the output signal may be a signal indicating an image including an analysis model used for thermal fluid analysis. Also, although the information processing devices 1 to 5 output an output signal including a single determination result such as a heat dissipation consideration signal, the information processing device according to the embodiments may output an output signal including multiple determination results.

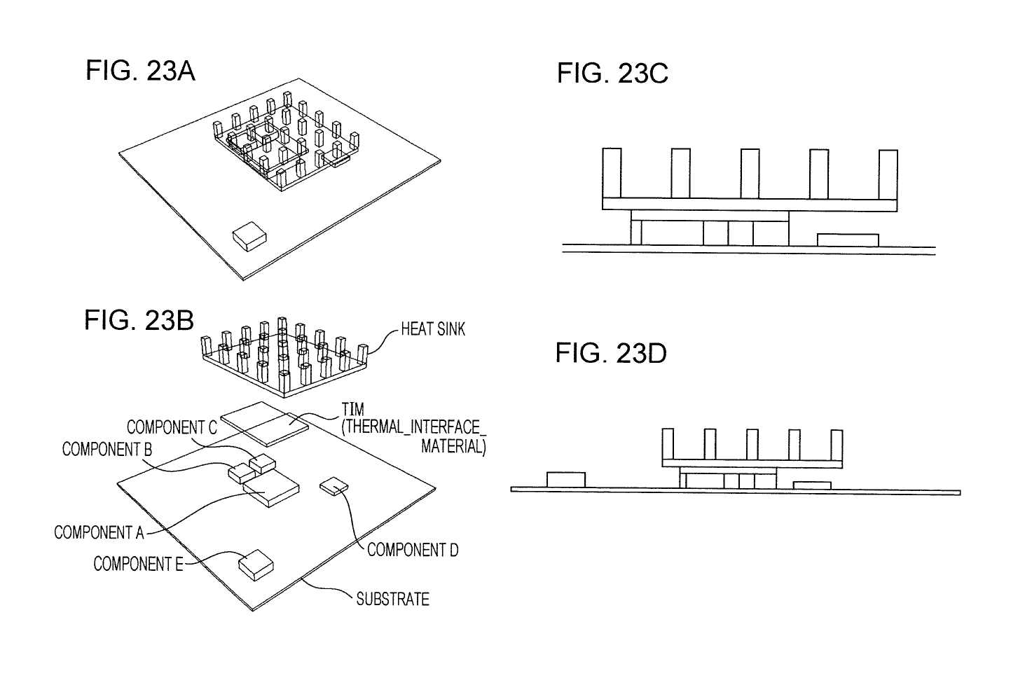

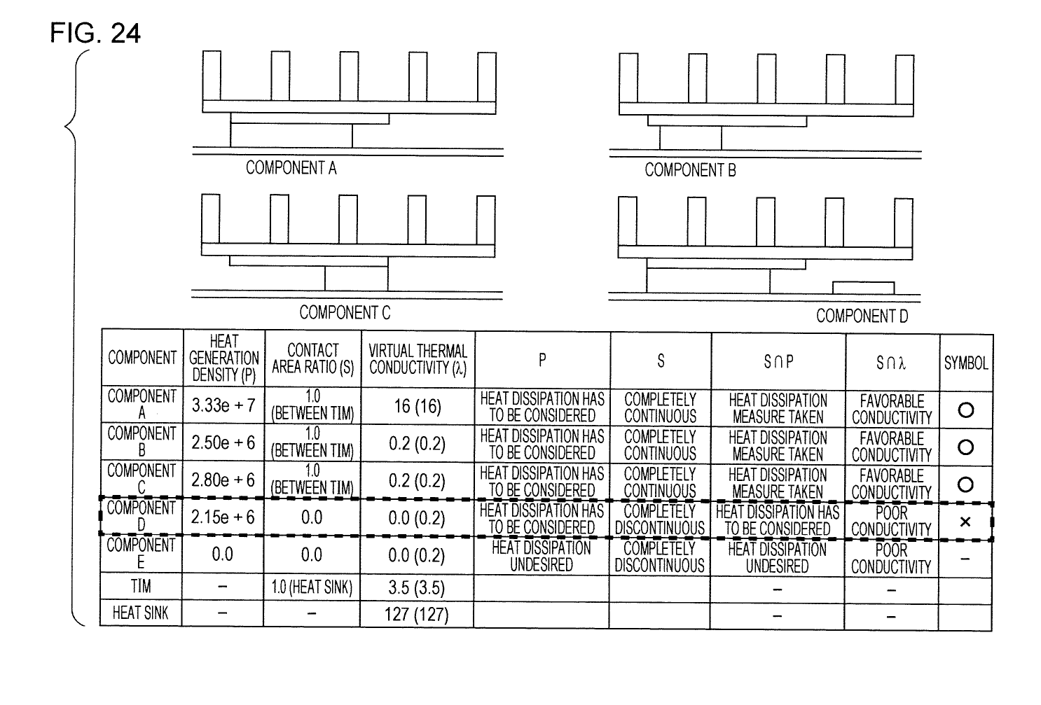

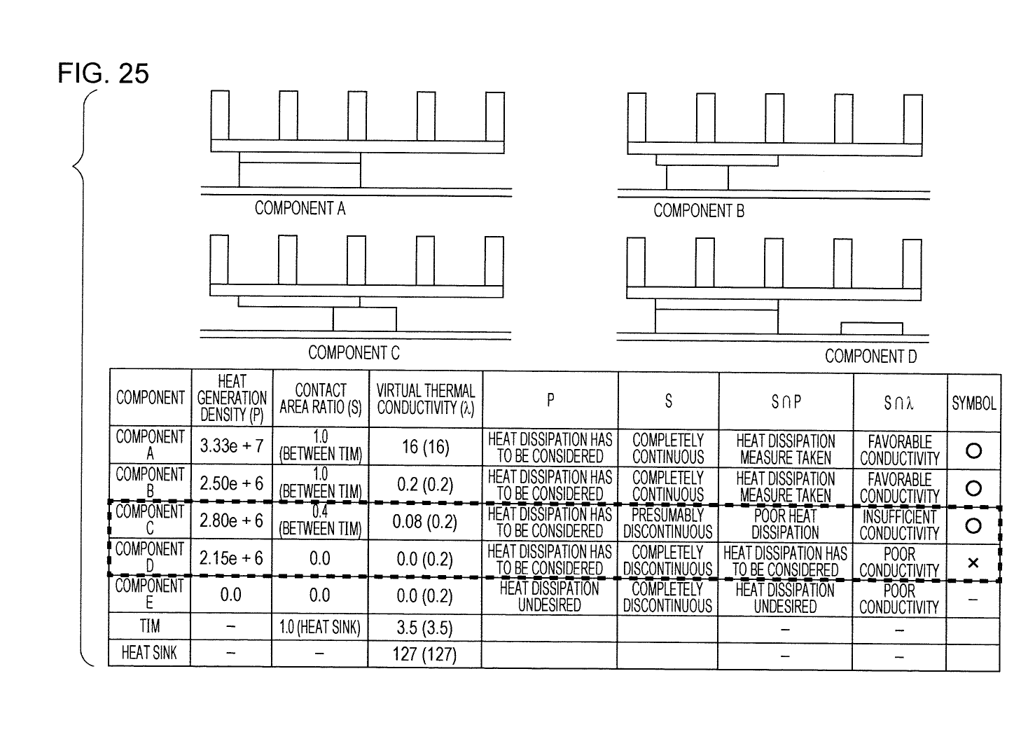

FIG. 23A is a perspective view illustrating an example analysis model, FIG. 23B is an exploded perspective view of the analysis model illustrated in FIG. 23A, FIG. 23C is a first side view of the analysis model illustrated in FIG. 23A, and FIG. 23D is a second side view of the analysis model illustrated in FIG. 23A. FIG. 24 is a diagram illustrating an example image corresponding to an output signal including the analysis model illustrated in FIG. 23A. FIG. 25 is a diagram illustrating an example image corresponding to an output signal including an analysis model which corresponds to the analysis models illustrated in FIG. 23A and in which C component is presumably discontinuous.

The mounting substrate has A component, B component, C component, D component, and E component disposed on the substrate, a TIM, and a heat sink. The thermal connection states between A component, B component, C component, and the TIM are completely continuous, and the thermal connection states between D component, E component and the TIM are completely discontinuous. The heat generation density of A component is 3.33×10⁷ [W/m³], the heat generation density of B component is 2.50×10⁶ [W/m³], and the heat generation density of C component is 2.80×10⁷ [W/m³]. The heat generation density of D component is 2.15×10⁶ [W/m³], and the heat generation density of E component is 0.0 [W/m³]. The heat generation density threshold value Py is 2.1×10⁶ [W/m³], the contact area threshold value Sx is 0.5, and the thermal conductivity threshold value λz is 0.1 [W/(mK)].

In the image illustrated in FIG. 24, a side view is displayed, in which for A component, B component, C component, and D component each with a non-zero heat generation amount, a connection state from the heat sink to each component may be seen with other components hidden. Also, in the image illustrated in FIG. 24, each of the heat generation density Pn, the contact area ratio Sn, and the virtual thermal conductivity λnn along with a determination result is displayed. In the image illustrated in FIG. 24, the contact area ratio Sn along with a component name in contact indicated in the parenthesis is displayed, and the virtual thermal conductivity λnn along with an actual thermal conductivity indicated in the parenthesis is displayed. In the image illustrated in FIG. 24, the determination for D component, for which consideration of heat dissipation is desired and which has a poor thermal conductivity, is displayed as “x”, and the determination for each of A component to C component is displayed as “O”.

The image illustrated in FIG. 25 differs from the image illustrated in FIG. 24 in that the determination for C component, which has poor heat dissipation and an insufficient thermal conductivity, is displayed as “Δ”.

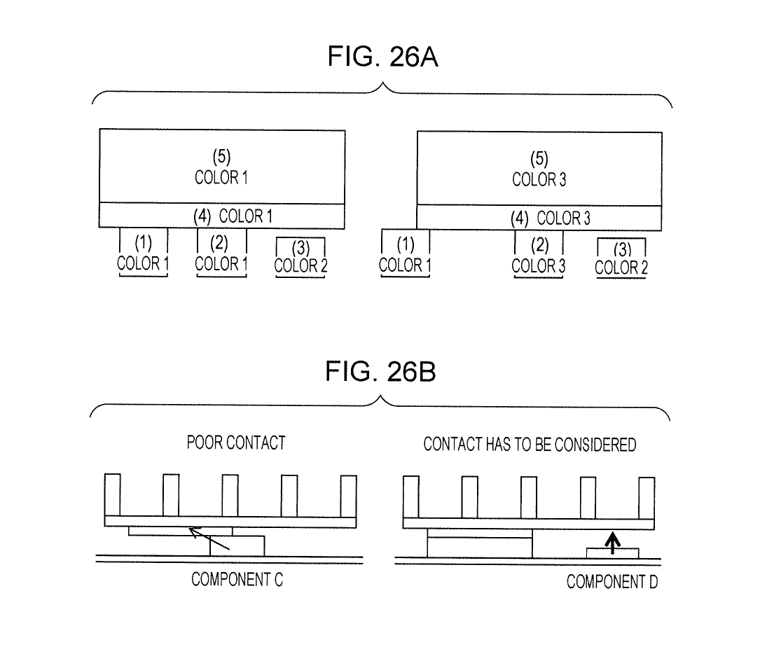

Also, the information processing device according to the embodiments may display determination results in an image that illustrates an analysis model. For instance, the information processing device according to the embodiments may indicate a component with insufficient heat dissipation and a component for which consideration of heat dissipation is desired, and a component with an insufficient thermal conductivity or a poor thermal conductivity by an arrow, and as illustrated in FIG. 26A, may change the color of each component. As an example, the information processing device according to the embodiments may indicate a component with insufficient heat dissipation or an insufficient thermal conductivity by a dashed arrow, and indicate a component for which consideration of heat dissipation is desired and a component with a poor thermal conductivity by a dashed-dotted line. Alternatively, as illustrated in FIG. 26B, the information processing device according to the embodiments may change the thickness and shape of an arrow, for instance, may indicate a component with insufficient heat dissipation or an insufficient thermal conductivity by a thin arrow, and may indicate a component for which consideration of heat dissipation is desired and a component with a poor thermal conductivity by a thick arrow. Alternatively, the information processing device according to the embodiments may display arrows with different brightness and saturation or in a flickering manner, the arrows indicating a component with insufficient heat dissipation and a component for which consideration of heat dissipation is desired, and a component with an insufficient thermal conductivity or a poor thermal conductivity. Alternatively, the information processing device according to the embodiments may display a component with insufficient heat dissipation and a component for which consideration of heat dissipation is desired, and a component with an insufficient thermal conductivity or a poor thermal conductivity in a flickering manner. Alternatively, icons may be displayed, which indicate a component with insufficient heat dissipation and a component for which consideration of heat dissipation is desired, and a component with an insufficient thermal conductivity or a poor thermal conductivity.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process, the process comprising:
obtaining a heat generation amount of a component via an interface;
calculating a unit heat-generation amount using the heat-generation amount of a component, and a unit size that is one of a volume of the component and a surface area of the component, the unit heat-generation amount being the heat-generation amount per the unit size;
determining whether the unit heat-generation amount is greater than a threshold value; and
causing an output device to output a signal for indicating that consideration of heat dissipation measures is desired for the component for which the unit heat-generation amount is determined to be greater than the threshold value.

2. The non-transitory, computer-readable recording medium according to claim 1, the process further comprising:
calculating a contact area ratio which indicates a ratio of a contact area to a contactable area, the contact area for indicating a contact area between the component and another component, the contactable area indicating a contactable area between the component and the another component;
determining a thermal-connection state between the component and the other component based on the contact area ratio; and
outputting a signal that indicates the determined thermal-connection state.

3. The non-transitory, computer-readable recording medium according to claim 2, the process further comprising:
determining whether consideration of heat dissipation measures is desired for the component, based on the unit heat-generation amount and the thermal-connection state, and outputting a signal that indicates that consideration of heat dissipation measures is desired for the component for which the consideration of the heat dissipation measures is determined to be desired.

4. The non-transitory, computer-readable recording medium according to claim 3, the process further comprising:
calculating a virtual thermal conductivity by multiplying a thermal conductivity of one of the component and the another component by the contact area ratio, the virtual thermal conductivity for indicating a thermal conductivity between the component and the other component;
determining a thermal-conductive state between the component and the another component based on the virtual thermal conductivity, and storing the determined thermal-conductive state; and
outputting a signal that indicates the determined thermal-conductive state.

5. The non-transitory, computer-readable recording medium according to claim 2, wherein the unit size is the volume of the component;

6. The non-transitory, computer-readable recording medium according to claim 2, the unit size is the surface area of the component;

7. An information processing device comprising:
a memory; and
a processor coupled to the memory, and the processor configured to:
obtain a heat generation amount of a component via an interface;
calculate a unit heat-generation amount using the heat-generation amount of a component, and a unit size that is one of a volume of the component and a surface area of the component, the unit heat-generation amount being the heat-generation amount per the unit size;
determine whether the unit heat-generation amount is greater than a threshold value; and
cause an output device to output a signal for indicating that consideration of heat dissipation measures is desired for the component for which the unit heat-generation amount is determined to be greater than the threshold value.

8. A heat dissipation measure determination method performed by a computer, the method comprising:
calculating a unit heat-generation amount using a heat-generation amount of a component, and the unit size that is one of a volume of the component and a surface area of the component, the unit heat-generation amount being the heat-generation amount per the unit size;
determining whether the unit heat-generation amount of the component is greater than a threshold value; and
causing an output device to output a signal for indicating that consideration of heat dissipation measures is desired for the component for which the unit heat-generation amount is determined to be greater than the threshold value.
